(19) United States
(12) Patent Application Publication
(10) Pub. No.: US 2026/0234329 A1
(43) Pub. Date: Aug. 13, 2026

(54) HIGH PERFORMANCE AMIDE-URETHANE MACROMOLECULES

(71) Applicant: Alliance for Energy Innovation, LLC, Golden, CO (US)

(72) Inventors: Tao DONG, Lakewood, CO (US); Cheng ZHANG, Golden, CO (US)

(21) Appl. No.: 19/470,897

(22) PCT Filed: Apr. 2, 2024
(86) PCT No.: PCT/US2024/022593

§ 371 Date: Sep. 30, 2025

Related U.S. Application Data
(60) Provisional application No. 63/494,874, filed on Apr. 7, 2023.

(51) Int. Cl. C08G 71/04

(52) U.S. Cl. CPC C08G 71/04

(57) ABSTRACT

This application provides a high-performance macromolecule that contains both amide bonds and urethane bonds, derived from renewable sources such as vegetable oil, and the method of making thereof.

### CROSS-REFERENCE TO RELATED APPLICATIONS

This application claims priority from U.S. Provisional Patent Application No. 63/494,874 filed on Apr. 7, 2023, the contents of which are incorporated herein by reference in the entirety.

### CONTRACTUAL ORIGIN

This invention was made with government support under Contract No. DE-AC36-08GO28308 awarded by the Department of Energy. The government has certain rights in the invention.

### FIELD OF THE APPLICATION

This application relates to a high-performance macromolecule that contains both amide bonds and urethane bonds, derived from renewable sources such as vegetable oil.

### BACKGROUND

Polyurethanes are one of the most used polymers in the world today and are utilized in a variety of useful materials such as foams, coatings, elastomers, and adhesives. However, isocyanate precursors are harmful at every stage of the polymer life cycle. Alternative pathways to produce polyurethane products without the use of isocyanates.

Dong et al., have proposed the manufacture of non-isocyanate polyurethanes (NIPUs) derived from environmentally friendly, renewably-sourced materials, such as fatty acids, amino acids and proteins. See U.S. Pat. No. 11,104,763, which is incorporated herein by reference. Unsaturated lipids, such as linseed oil or soybean oil, can be converted to carbonates which can then be reacted with polyamines. Examples of polyamines include decarboxylated amino acids, cadaverine (CA), 1,4-butane diamine or amino acid derivatives such as tyrosine-CA. Crosslinked polyurethanes having good break stress properties (as high as 29 MPa) and/or break elongation (as high as about 129%). However, increased break stress properties generally accompanied low elongation properties, perhaps correlating with the degree of crosslinking.

In addition, Dong et al. describe NIPU foams wherein a blowing agent is added or formed during the urethane formation, forming NIPUs with diverse mechanical and thermal properties. See US Publication 2022/0041830, which is incorporated herein by reference.

There remains a need to produce polyurethane materials with improved and/or tailored mechanical and thermal properties from renewable resources.

### SUMMARY OF THE INVENTION

The invention relates in part to the surprising discovery that polymers formed by the incorporation of urethane moieties, amide moieties, and hydrophobic moieties can result in polymers having superior mechanical properties, such as both high mechanical strength and high elongation at break.

The invention includes a macromolecule or polymer having a tensile strength of at least about 2 MPa and elongation at break of at least about 200% according to ASTM D638, wherein the macromolecule comprises a plurality of amidated prepolymer chains, each amidated prepolymer chain comprising an amine (—NH₂) group at each chain end, derived from a carboxylic acid monomer and an amine monomer, wherein the amine monomer is preferably added in an overstoichiometric amount; wherein each amidated prepolymer chain is linked to one or more amidated prepolymer chains via a cyclic carbonate monomer that preferably comprises at least two cyclic carbonate groups; wherein the number of repeating unit (n) in each amidated prepolymer chain is preferably between about 1 to about 10 or more, between about 1 to about 6, or between about 1 to about 5; and wherein the molar ratio of the amidated prepolymer to the cyclic carbonate monomer is preferably between about 0.1 to about 2 or more, between about 0.1 to about 1.5, or between about 0.1 to about 1.

### BRIEF DESCRIPTION OF THE DRAWINGS

FIG. 1 illustrates plots of tensile strength versus elongation-at-break for various NIPUs (amide-based—solid circles; other biobased NIPUs—empty circles). Amide-based NIPUs refer to NIPUs derived from amidated prepolymers and cyclic carbonate monomers and thus contain the amide groups as described in this application. Other biobased NIPUs refer to NIPUs that do not contain amide groups, e.g., NIPUs derived from diamines and cyclic carbonate monomers as described in this application.

FIG. 2A illustrates the tensile curve of a NIPU synthesized from reacting a carbonated linseed triglyceride with BDA 350, according to some embodiments of the present disclosure.

FIG. 2B illustrates the tensile curve of a NIPU synthesized from reacting a carbonated linseed triglyceride with BDA 850, according to some embodiments of the present disclosure.

FIG. 2C illustrates the tensile curves of a NIPU synthesized from reacting a carbonated linseed triglyceride with BDA 1300, according to some embodiments of the present disclosure.

FIG. 3 illustrates tensile curves of NIPUs synthesized from CC3 and three different amidated prepolymers, BDA 1300, BDA 850, and BDA 350, respectively, according to some embodiments of the present disclosure.

FIG. 4 illustrates tensile curves of NIPUs synthesized from CC3 and three different amidated prepolymers, BDA 450, HDA 450, and MXDA 350, respectively, according to some embodiments of the present disclosure.

FIG. 5 illustrates tensile curves of NIPUs synthesized using BDA850 and different cyclic carbonate monomers, CC3, GE25, GE31, and GE61, respectively, according to some embodiments of the present disclosure.

FIG. 6 illustrates tensile curves of NIPUs synthesized from CC3 and BDA530, with the presence of 2 wt % SDS and 3 wt % PDMS with M_{w} of 92,000 (dark data set) and with the absence of them (light data set), respectively, according to some embodiments of the present disclosure.

FIG. 7 illustrates transmission scanning microscopy (TEM) images of NIPUs synthesized from CC3 and BDA530 (A), CC3 and BDA530 with 3 wt % SDS (B), and CC3 and BDA530 with 2 wt % SDS and 3 wt % PDMS with M_{w} of 92,000 (C).

FIG. 8 illustrates photographs of these reprocessable NIPU vitrimers derived from CC3 and BDA450, BDA850, or BDA1300, versus these unreprocessable NIPU thermosets derived from carbonated GE31 and BDA450, BDA850, or BDA1300, according to some embodiments of the present disclosure.

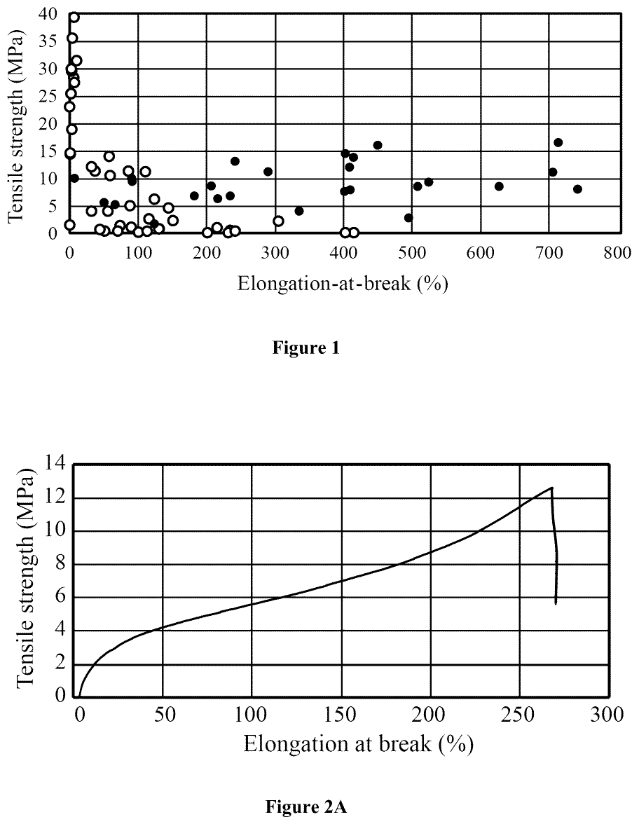

### DETAILED DESCRIPTION

The invention includes a macromolecule or polymer having a tensile strength of at least about 2 MPa and elongation at break of at least about 200% according to ASTM D638 wherein the macromolecule comprises a plurality of amidated prepolymer chains, each amidated prepolymer chain comprising an amine (—NH₂) group at each chain end, derived from a carboxylic acid monomer and an amine monomer, preferably added in an overstoichiometric amount; wherein each amidated prepolymer chain is linked to one or more amidated prepolymer chains via a cyclic carbonate monomer that preferably comprises at least two cyclic carbonate groups; wherein the number of repeating unit (n) in each amidated prepolymer chain is preferably between about 1 to about 10 or more; and wherein the molar ratio of the amidated prepolymer to the cyclic carbonate monomer is preferably between about 0.5 to about 2 or more.

The terms “macromolecule,” “polymer” and “resin” are used interchangeably herein to describe the products produced by the processes described and variations thereof, as discussed in more detail below.

Cyclic Carbonate Monomer The cyclic carbonate monomers used in this application are organic molecules that contain a substituted or unsubstituted hydrocarbon group and at least one cyclic carbonate groups (i.e., ethylene carbonate)

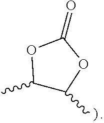

In this application, the term “cyclic carbonate group” specifically refers to ethylene carbonate

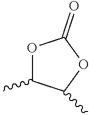

unless defined otherwise. In a preferred embodiment, the cyclic carbonate monomers are bio-based, such as those derived from fatty acids, esters or triglycerides. Preferred cyclic carbonate monomers may contain one or more substituted or unsubstituted C₆-C₂₄ hydrocarbon groups and two, three, or four cyclic carbonate groups. The cyclic carbonate monomers may contain a substituted or unsubstituted C₈-C₂₀ hydrocarbon group and two, three, or four cyclic carbonate groups. In some embodiments, the cyclic carbonate monomers may contain a substituted or unsubstituted C₈-C₂₀ hydrocarbon group and two cyclic carbonate groups. In some embodiments, the cyclic carbonate monomers may contain a substituted or unsubstituted C₈-C₂₀ hydrocarbon group and three cyclic carbonate groups. In some embodiments, the cyclic carbonate monomers may contain a substituted or unsubstituted C₈-C₂₀ hydrocarbon group and four cyclic carbonate groups. The hydrocarbon group may contain both aliphatic and aromatic molecular fragments, and the aliphatic molecular fragments may include further linear, branched, and cyclic fragments. The hydrocarbon group may be further substituted with heteroatoms such as N, S, and O. The hydrocarbon group may further contain —COO—, —C(O)—, —O—, —NR¹C(O)—, —CONR¹—, —NR¹—, —OR¹, —COOR¹, —C(O)R¹—, —NR¹C(O)R², or —C(O)NR¹R², —NR¹R²; wherein R¹ and R² are each independently hydrogen, substituted or unsubstituted alkyl, or substituted or unsubstituted alkenyl. In some preferred embodiments, the hydrocarbon group does not contain any other elements except for C and H. In other preferred embodiments, the hydrocarbon group contains or is further substituted by —O—, —COO—, or —OH. For example, preferred cyclic carbonate monomers are C₆-C₂₄ hydrocarbons substituted by a terminal COOH, COOR¹ or —OH.

Substituents for R¹ can include any group or moiety which does not prevent or substantially interfere with the reaction of a cyclic carbonate and amine. The ability of a moiety to prevent the reaction of a cyclic carbonate and amine can be readily established empirically. The term “substituted” refers to substitution by independent replacement of one, two, or three or more of the hydrogen atoms with substituents including, but not limited to, —F, —C₁, —Br, —I, —OH, C₁-C₁₂-alkyl; C₂-C₁₂-alkenyl, C₂-C₁₂-alkynyl, —C₃-C₁₂-cycloalkyl, protected hydroxy, —NO₂, —N₃, —CN, —NH₂, protected amino, oxo, thioxo, —NH—C₁-C₁₂-alkyl, —NH—C₂-C₅-alkenyl, —NH—C₂-C₈-alkynyl, —NH—C₃-C₁₂-cycloalkyl, —NH-aryl, —NH-heteroaryl, —NH-heterocycloalkyl, -dialkylamino, -diarylamino, -diheteroarylamino, —O—C₁-C₁₂-alkyl, —O—C₂-C₈-alkenyl, —O—C₂-C₈-alkynyl, —O—C₃-C₁₂-cycloalkyl, —O-aryl, —O-heteroaryl, —O— heterocycloalkyl, —C(O)—C₁-C₁₂-alkyl, —C(O)—C₂-C₅-alkenyl, —C(O)—C₂-C₈-alkynyl, —C(O)—C₃-C₁₂-cycloalkyl, —C(O)-aryl, —C(O)-heteroaryl, —C(O)-heterocycloalkyl, —CONH₂, —CONH—C₁. C₁₂-alkyl, —CONH—C₂-C₅-alkenyl, —CONH—C₂-C₈-alkynyl, —CONH—C₃-C₁₂-cycloalkyl, —CONH-aryl, —CONH-heteroaryl, —CONH-heterocycloalkyl, —OCO₂-C₁-C₁₂-alkyl, —OCO₂-C₂-C₈-alkenyl, —OCO₂-C₂-C₈-alkynyl, —OCO₂-C₃-C₁₂-cycloalkyl, OCO₂-aryl, —OCO₂-heteroaryl, —OCO₂-heterocycloalkyl, —CO₂-C₁-C₁₂ alkyl, —CO₂-C₂-C₈ alkenyl, —CO₂-C₂-C₈ alkynyl, CO₂—C₃-C₁₂-cycloalkyl, —CO₂-aryl, CO₂-heteroaryl, CO₂-heterocyloalkyl, —OCONH₂, —OCONH—C₁C₁₂-alkyl, —OCONH—C₂-C₅-alkenyl, —OCONH—C₂-C₈-alkynyl, —OCONH—C₃-C₁₂-cycloalkyl, —OCONH-aryl, —OCONH-heteroaryl, —OCONH-heterocyclo-alkyl, —NHC(O)H, —NHC(O)—C₁. C₁₂-alkyl, —NHC(O)—C₂-C₅-alkenyl, —NHC(O)—C₂-C₅-alkynyl, —NHC(O)—C₃-C₁₂-cycloalkyl, —NHC(O)-aryl, —NHC(O)-heteroaryl, —NHC(O)-heterocyclo-alkyl, —NHCO₂-C₁-C₁₂-alkyl, —NHCO₂-C₂-C₅-alkenyl, —NHCO₂-C₂-C₈-alkynyl, —NHCO₂-C₃-C₁₂-cycloalkyl, —NHCO₂-aryl, —NHCO₂-heteroaryl, —NHCO₂— heterocycloalkyl, —NHC(O)NH₂, —NHC(O)NH—C₁-C₁₂-alkyl, —NHC(O)NH—C₂-C₅-alkenyl, —NHC(O)NH—C₂-C₅-alkynyl, —NHC(O)NH—C₃-C₁₂-cycloalkyl, —NHC(O)NH-aryl, —NHC(O)NH-heteroaryl, —NHC(O)NH-heterocycloalkyl, NHC(S)NH₂, —NHC(S)NH—C₁-C₁₂-alkyl, —NHC(S)NH—C₂-C₅-alkenyl, —NHC(S)NH—C₂-C₅-alkynyl, —NHC(S)NH—C₃-C₁₂-cycloalkyl, —NHC(S)NH-aryl, —NHC(S)NH-heteroaryl, —NHC(S)NH— heterocycloalkyl, —NHC(NH)NH₂, —NHC(NH)NH—C₁-C₁₂-alkyl, —NHC(NH)NH—C₂-C₅-alkenyl, —NHC(NH)NH—C₂-C₅-alkynyl, —NHC(NH)NH—C₃-C₁₂-cycloalkyl, —NHC(NH)NH-aryl, —NHC(NH)NH-heteroaryl, —NHC(NH)NH-heterocycloalkyl, —NHC(NH)—C₁-C₁₂-alkyl, —NHC(NH)—C₂-C₅-alkenyl, —NHC(NH)—C₂-C₅-alkynyl, —NHC(NH)—C₃-C₁₂-cycloalkyl, —NHC(NH)-aryl, —NHC(NH)-heteroaryl, —NHC(NH)-heterocycloalkyl, —C(NH)NH—C₁-C₁₂-alkyl, —C(NH)NH—C₂-C₅-alkenyl, —C(NH)NH—C₂-C₅-alkynyl, —C(NH)NH—C₃-C₁₂-cycloalkyl, —C(NH)NH-aryl, —C(NH)NH-heteroaryl, —C(NH)NH-heterocycloalkyl, —S(O)—C₁-C₁₂-alkyl, —S(O)—C₂-C₅-alkenyl, —S(O)—C₂-C₈-alkynyl, —S(O)—C₃-C₁₂-cycloalkyl, —S(O)-aryl, —S(O)— heteroaryl, —S(O)-heterocycloalkyl, —SO₂NH₂, —SO₂NH—C₁-C₁₂-alkyl, —SO₂NH—C₂-C₅-alkenyl, —SO₂NH—C₂-C₈-alkynyl, —SO₂NH—C₃-C₁₂-cycloalkyl, —SO₂NH-aryl, —SO₂NH-heteroaryl, —SO₂NH-heterocycloalkyl, —NHSO₂-C₁-C₁₂-alkyl, —NHSO₂-C₂-C₅-alkenyl, —NHSO₂-C₂-C₅-alkynyl, —NHSO₂-C₃-C₁₂-cycloalkyl, —NHSO₂-aryl, —NHSO₂-heteroaryl, —NHSO₂— heterocycloalkyl, —CH₂NH₂, —CH₂SO₂CH₃, -aryl, -arylalkyl, -heteroaryl, -heteroarylalkyl, -heterocycloalkyl, —C₃-C₁₂-cycloalkyl, polyalkoxyalkyl, polyalkoxy, -methoxymethoxy, -methoxyethoxy, —SH, —S—C₁-C₁₂-alkyl, —S—C₂-C₅-alkenyl, —S—C₂-C₈-alkynyl, —S—C₃-C₁₂-cycloalkyl, —S-aryl, —S-heteroaryl, —S-heterocycloalkyl, or methylthio-methyl. In certain embodiments, the substituents are independently selected from halo, preferably C₁ and F; C₁-C₄-alkyl, preferably methyl and ethyl; halo-C₁-C₄-alkyl, such as fluoromethyl, difluoromethyl, and trifluoromethyl; C₂-C₄-alkenyl; halo-C₂-C₄-alkenyl; C₃-C₆-cycloalkyl, such as cyclopropyl; C₁-C₄-alkoxy, such as methoxy and ethoxy; halo-C₁-C₄-alkoxy, such as fluoromethoxy, difluoromethoxy, and trifluoromethoxy; acetyl; —OH; NH₂; C₁-C₄-alkylamino; di(C₁-C₄-alkyl)amino; and NO₂. It is understood that the aryls, heteroaryls, alkyls, and the like can be further substituted. In some cases, each substituent in a substituted moiety is additionally optionally substituted with one or more groups, each group being independently selected from C₁-C₄-alkyl; —CF₃, —OCH₃, —OCF₃, —F, —C₁, —Br, —I, —OH, —NO₂, and —NH₂. Preferably, a substituted alkyl group is substituted with one or more halogen atoms, more preferably one or more fluorine or chlorine atoms.

The cyclic carbonate monomer can be derived from a bio-based source, such as rom vegetables, animals or algae, including vegetable oil, algal oil or fish oil. The monomer can also be derived from petroleum or synthetic routes, as will be discussed in more detail below.

Cyclic Carbonate Monomer Derived from Vegetable Oil

The cyclic carbonate monomers used in this application can preferably be derived from vegetable oils. Vegetable oils are mixtures of triglycerides derived from glycerol and fatty acids that can be divided into saturated fatty acids, monounsaturated fatty acids, and polyunsaturated fatty acids. Saturated fatty acids include, for example, palmitic acid, stearic acid, and arachidic acid. Monounsaturated fatty acids include, for example, palmitoleic acid, oleic acid, and eicosenoic acid. Polyunsaturated fatty acids include, for example, linoleic acid and α-linolenic acid. Vegetable oil preferably contain more than 35% polyunsaturated fatty acids by weight of total lipid in its natural status, such as Brazil nut oil, corn oil, cottonseed oil, linseed oil (also called flaxseed oil), grape seed oil, hemp seed oil, rice bran oil, sesame oil, soybean oil, and walnut oil (see US National Nutrient Database, Release 28, United States Department of Agriculture. May 2016. Retrieved 6 Sep. 2017), more preferably linseed oil or α-linolenic acid. The word “linseed” is used in this application in some contexts as a matter of convenience and shorthand to refer to α-linolenic acid as the α-linolenic acid actually used herein was sourced from linseed oil.

The cyclic carbonate monomer can be a carbonated triglyceride, a carbonated diglyceride, a carbonated fatty acid, a carbonated fatty acid ester or the like.

In some embodiments, the cyclic carbonate monomer contains three cyclic carbonate groups and the vegetable oil used for derivation is any one of those mentioned above.

Preferably, the vegetable oils used for derivation are those in which the major fatty acids of the more than 35% polyunsaturated fatty acids are α-linolenic acid that is characterized by the presence of three double bonds, such as linseed oil.

In some embodiments, the cyclic carbonate monomer contains more than three cyclic carbonate groups. This can be conveniently found when using triglycerides or diglycerides of unsaturated fatty acids, for example.

To prepare preferred cyclic carbonate monomers, double bonds on the monounsaturated and polyunsaturated fatty acids can be first epoxidized. Epoxidized triglycerides can be subsequently converted to fatty acid esters having epoxy groups via transesterification. As a nonlimiting example, the epoxidized triglycerides can react with methanol, ethanol, propanol, or butanol; and are converted to fatty acid methyl esters (FAMEs), fatty acid ethyl esters, fatty acid propyl esters, or fatty acid butyl ester, respectively. The epoxy groups can be converted to cyclic carbonate groups by reaction with CO₂. Where any fatty acid is characterized by more than one epoxy group, the conversion can be to one, two, three or all epoxides. In one embodiment, the product is a mixture of carbonated esters that contain one or more cyclic carbonate groups and/or the residue (i.e., untransesterificated) carbonated triglycerides. The product can be used as is or can preferably be purified to obtain the desirable cyclic carbonate monomers, for example via a solvent separation method based on the different hydrophilicities of the carbonated esters and/or the residue carbonated triglycerides. Various desirable cyclic carbonate monomers can be derived from the vegetable oils following the four steps described herein: epoxidation, transesterification, carbonation, and purification. In some embodiments, the order of the four steps can be varied, such as transesterification as the first step, followed by epoxidation, carbonation, and purification.

As a nonlimiting example, the α-linolenic acid content in linseed oil makes linseed oil a desirable starting material to prepare the cyclic carbonate monomer of this invention. The typical fatty acid content in linseed oil can be α-linolenic acid (51.9-55.2%), linoleic acid (14.2-17%), oleic acid (18.5-22.6%), palmitic acid (about 7%), stearic acid (3.4-4.6%). (The triglyceride composition of linseed oil. Vereshchagin et al. Journal of the American Oil Chemists Society volume 42, 970-974, 1965. doi:10.1007/BF02632457.)

The linseed oil triglyceride is a mixture of triglycerides derived from glycerol and any combinations of fatty acids including α-linolenic acid, linoleic acid, oleic acid, palmitic acid, and stearic acid. Provided below is a representative example of one possible triglyceride structure (Linseed TG (I)) derived of α-linolenic acid, linoleic acid, and oleic acid in the linseed oil triglyceride.

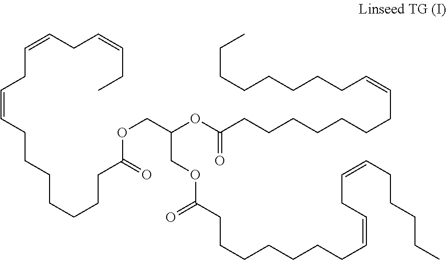 [SMILES: CC/C=C\C/C=C\C/C=C\CCCCCCCC(=O)OCC(COC(=O)CCCCCCC/C=C\C/C=C\CCCCC)OC(=O)CCCCCCC/C=C\CCCCCCCC]

Linseed TG (I) and methanol are used for example to illustrate the steps of preparing cyclic carbonate monomers from the linseed oil in Scheme (I):

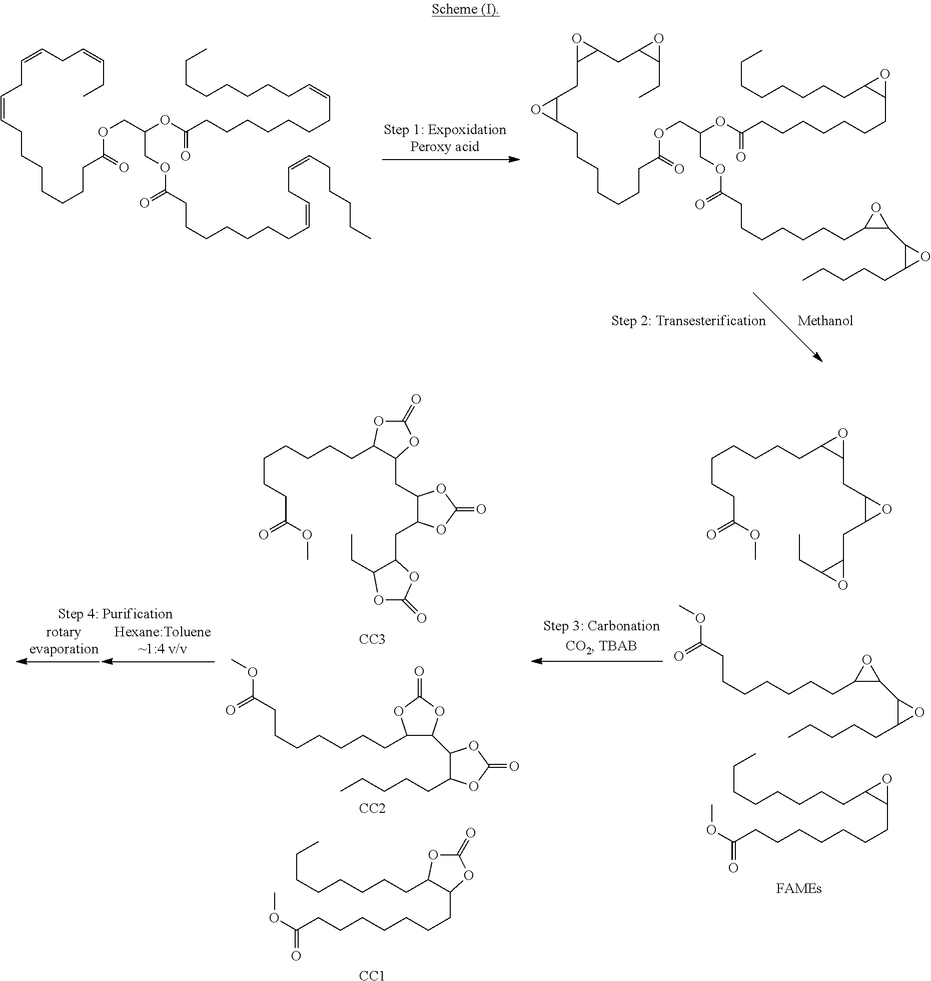

Steps 1-3: As shown in Scheme (I), the double bonds of Linseed TG (I) react with peroxy acid (—CO₃H) to form epoxy groups. Epoxidized Linseed TG (I) undergo transesterification with methanol to produce epoxidized esters or FAMEs. Carbonation is subsequently conducted to these epoxidized esters or FAMEs, e.g., using tetrabutylammonium bromide (TBAB) as a catalyst under 500 psi CO₂, resulting in a mixture of carbonated esters that contains 1, 2, and 3 cyclic carbonate groups, respectively. Finally, α-linolenic acid in Linseed oil TG (I) is converted to an ester that contains three cyclic carbonate groups (CC3), linoleic acid in Linseed oil TG (I) is converted to an ester that contains two cyclic carbonate groups (CC2), and oleic acid in Linseed oil TG (I) is converted to an ester that contains one cyclic carbonate group (CC1). Of course, the epoxidation and subsequent carbonation of a fatty acid may not be driven to completion. Thus, the material called “linseed CC3” may contain a fraction of molecules that have less than three cyclic carbonates. The products made with such materials are intended to be a part of the invention.

When Steps 1-3 are conducted to linseed oil, triglycerides that have different structures than Linseed TG (I) undergo the same reactions (i.e., epoxidation, transesterification, and carbonation), resulting in esters that have zero cyclic carbonate group (CC0) from saturated fatty acids, CC1 from monounsaturated fatty acids, CC2 from linoleic acid, and CC3 from α-linolenic acid.

As used herein, while CC2 and CC3 are referred to the specific compounds shown in Scheme (I), CC0 represents all esters produced by the process as described herein that contain zero cyclic carbonate group, including esters derived from palmitic acid, stearic acid, and arachidic acid, and CC1 represents all esters produced by the process as described herein that contain one cyclic carbonate group, including esters derived from palmitoleic acid, oleic acid, and eicosenoic acid.

In some cases, commercially available epoxidized linseed oil can be used as the starting material to prepare cyclic carbonate monomers and Step 1 can be therefore absent. In some cases, Steps 1-3 can be conducted in a different order to prepare cyclic carbonate monomers, such as following the order of Step 2, Step 1, and Step 3.

Given the fatty acid content in linseed oil, wherein α-linolenic acid is 51.9-55.2% of total fatty acids, the major carbonated ester of the produced mixture is CC3. The methyl ester is preferred.

Step 4: To react with amidated prepolymer and form amide-urethane macromolecules, the cyclic carbonate monomers should contain at least one, preferably two, cyclic carbonate groups. Therefore, CC0 and CC1 are preferably removed from the produced ester mixture. According to the target product, the produced mixture can be purified to obtain CC2 monomer and/or CC3 monomer. For example, when the target product is thermoplastic, CC2 is a preferred monomer and thus purified from the ester mixture; when the target product is thermoset/elastomer/vitrimer, CC3 is a preferred monomer and thus purified from the ester mixture after step 3. As described above, a solvent separation method can be used to obtain the desirable cyclic carbonate monomer based on the hydrophilicity of each methyl ester.

For example, a preferred cyclic carbonate monomer is CC3. The cyclic carbonate group is hydrophilic; the hydrophilicity of CC3 is >CC2>CC1>CC0. Hexane and toluene (~1:4, v/v) are added to the ester mixture (e.g., solvent/ester mixture=~5, w/w). CC0, CC1, and a portion of CC2 are extracted into hydrophobic hexane layer (upper layer), whereas the more hydrophilic CC3 molecule stays in toluene phase (bottom layer). The toluene phase is then separated, and CC3 monomer is obtained by rotary evaporation to remove residue solvent. The purity of final CC3 monomer is calculated by ¹H NMR to be 80-90%. Accordingly, the functionality of the final CC3 monomer (i.e., the number of cyclic carbonate groups per CC3 molecule) is 2.8-2.9. In some cases, several rounds of purification may be conducted to improve the purity of CC3.

In some cases, based on the desirable cyclic carbonate monomer, other solvents can be used in the scalable solvent separation method in Step 4, such as butane, pentane, xylene, ether, gasoline, diesel, kerosene, acetone, ethyl acetate, chloroform, dichloromethane, and/or fluorocarbon solvents. In some cases, the purification method may be completed at a temperature between about −20° C. and about 200° C. In some cases, the separation method may be performed using light and heavy phases directed in a counter-current fashion and/or in a co-current fashion.

The purification method as described herein can be used to purify or enrich compounds containing cyclic carbonate from any feedstock, such as plant based, microbial based, and animal based fatty acid resources.

In some embodiments, cyclic carbonate monomers that contain two cyclic carbonate groups (e.g., CC2) can be prepared from vegetable oil that is rich in doubly unsaturated fatty acid (e.g., linoleic acid), including Brazil nut oil, corn oil, cottonseed oil, grape seed oil, hemp seed oil, rice bran oil, sesame oil, soybean oil, and walnut oil, following the process as described herein.

As illustrated above, the cyclic carbonate monomer derived from vegetable oils, such as FAMEs, CC2, and CC3, also contain an ester group such as methyl ester, and thus can be further functionalized by transesterification with a diol. For example, CC3 can be further functionalized to yield a diester as shown below:

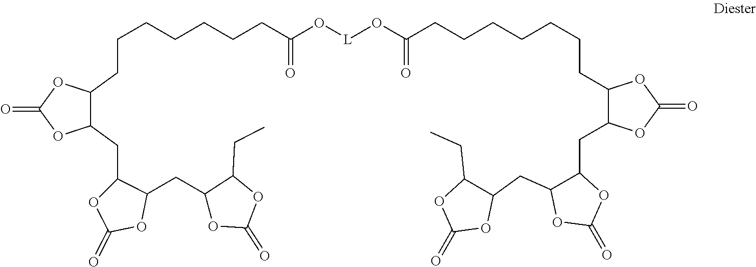

L represents a linker group in the diester and can be derived from a polyester such as poly(ethylene) glycol or polytetrahydrofuran (i.e., polyTHF), or a dimer diol. Non-limiting examples of HO-L-OH are PEG500, PEG1500, PolyTHF250, PolyTHF650, PolyTHF1000, PolyTHF2000. Therefore, the cyclic carbonate monomer can further comprise additional linkers.

Cyclic Carbonate Monomer Prepared from Alternative Routes

In some embodiments, the cyclic carbonate monomers may also be derived from animal oils such as fish oil. In some embodiments, the cyclic carbonate monomers may also be prepared from other commercially available biobased or bioderived materials, such as biobased or bioderived compounds containing one or more epoxy groups. In some embodiments, the cyclic carbonate monomers are prepared from biobased or bioderived materials containing two epoxy groups. In some embodiments, the cyclic carbonate monomers are prepared from biobased or bioderived materials containing three epoxy groups. In some embodiments, the cyclic carbonate monomers are prepared from biobased or bioderived materials containing four epoxy groups.

As a nonlimiting example, the cyclic carbonate monomers can be produced from glycidyl ethers, including but not limited to diglycidyl ethers (e.g., resorcinol diglycidyl ether, butanediol diglycidyl ether such as 1,4-butanediol diglycidyl ether, hexanediol diglycidyl ether such as 1,6-hexanediol diglycidyl ether, and cyclohexanedimethanol diglycidyl ether), triglycidyl ethers (e.g., trimethylolethane triglycidyl ether, and trimethylolpropane triglycidyl ether, propoxylated glycerin triglycidyl ether), tetraglycidyl ether (e.g., pentaerythritol glycidyl ether). Such compounds are sold as the Huntsman ERISYS® series of glycidyl ethers, including products such as GE21, GE30, GE36, GE40, ERISYS® EGDGE, ERISYS® GA 240, and/or any of the molecules from the EPALLOY® Series, etc. Epoxy groups of these glycidyl ethers can be converted to cyclic carbonates via catalytic reaction of CO₂ in the presence of tetrabutylammonium bromide (TBAB) (5 mol % with respect to epoxy groups). In the typical synthesis, the epoxies and TBAB are placed in a parr reactor at 140° C. with a CO₂ pressure of 500 psi. The level of conversion is monitored via 1H NMR spectroscopy by the disappearance of the proton signals associated with the epoxy group. Upon completion, the product is dissolved in ethyl acetate and washed three times with distilled water to remove the TBAB catalyst. The organic layer is then rotary evaporated to remove remaining solvent and to obtain cyclic carbonate monomers. The dried cyclic carbonate monomers are collected and stored for future use in synthesizing amide-urethane macromolecules of this invention. The resultant cyclic carbonate monomers may contain more than one cyclic carbonate group, such as two, three, and four cyclic carbonate groups.

Representative examples of cyclic carbonate monomers prepared from glycidyl ethers are provided as below.

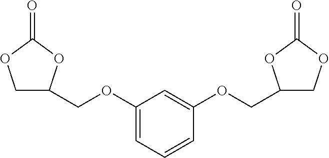 [SMILES: O=C1OCC(COc2cccc(OCC3COC(=O)O3)c2)O1]

Carbonated RDGE (cyclic carbonate monomer containing two cyclic carbonate groups produced from resorcinol diglycidyl ether, RDGE)

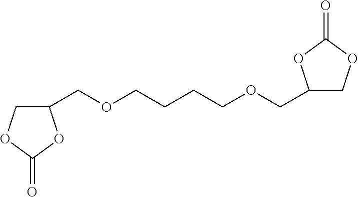 [SMILES: O=C1OCC(COCCCCOCC2COC(=O)O2)O1]

Carbonated GE21 (cyclic carbonate monomer containing two cyclic carbonate groups produced from 1,4-butanediol diglycidyl ether, GE21)

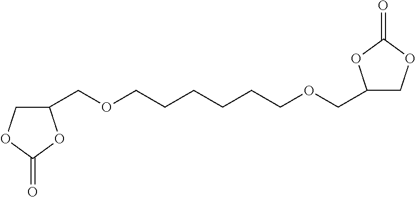 [SMILES: O=C1OCC(COCCCCCCOCC2COC(=O)O2)O1]

Carbonated GE25 (cyclic carbonate monomer containing two cyclic carbonate groups produced from 1,6-hexanediol diglycidyl ether, GE25)

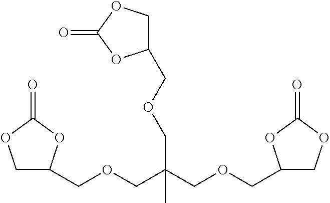 [SMILES: CC(COCC1COC(=O)O1)(COCC1COC(=O)O1)COCC1COC(=O)O1]

Carbonated GE31 (cyclic carbonate monomer containing three cyclic carbonate groups produced from trimethylolethane triglycidyl ether, GE31)

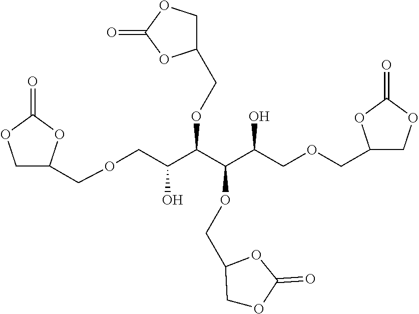 [SMILES: O=C1OCC(COC[C@@H](O)[C@@H](OCC2COC(=O)O2)[C@H](OCC2COC(=O)O2)[C@@H](O)COCC2COC(=O)O2)O1]

Carbonated GE61 (cyclic carbonate monomer containing four cyclic carbonate groups produced from sorbitol polyglycidyl ether, GE61)

In this application, both cyclic carbonate monomers based on vegetable oil and glycidyl ester are used for the preparation of amide-urethane macromolecules and the mechanical properties of final products prepared from different starting materials are studied and compared.

Combination of Cyclic Carbonate Monomers In some embodiments, the cyclic carbonate monomer can be a combination of more than one cyclic carbonate monomers defined above. In some embodiments, the cyclic carbonate monomer can be a combination of two cyclic carbonate monomers defined above.

In some embodiments, the cyclic carbonate monomer can be a combination of two cyclic carbonate monomers defined above, such as CC3 and carbonated RDGE, carbonated RDGE and carbonated GE21, carbonated RDGE and carbonated GE25.

### Additional Cyclic Carbonate Monomers

In some embodiments, the cyclic carbonate monomer can further comprise a second cyclic carbonate monomer in addition to the cyclic carbonate monomer defined above. The cyclic carbonate monomer defined above is thus referred as a first cyclic carbonate monomer.

A second cyclic carbonate monomer is a compound that contains two or three cyclic carbonate groups and is different from the first cyclic carbonate monomer, the content of which is less than about 50% of the total cyclic carbonate monomer by weight. The purpose of including a second cyclic carbonate monomer is to further tailor the structure and thus the properties of amide-urethan macromolecule such as tensile strength and resistance to environment damage. Therefore, a second cyclic carbonate monomer is analogous to a reactive additive to enhance the performance of materials. A second cyclic carbonate monomer can be prepared from commercially available epoxy products through carbonation.

A non-limiting example of such epoxy products is B-tough™ C2x from Croda:

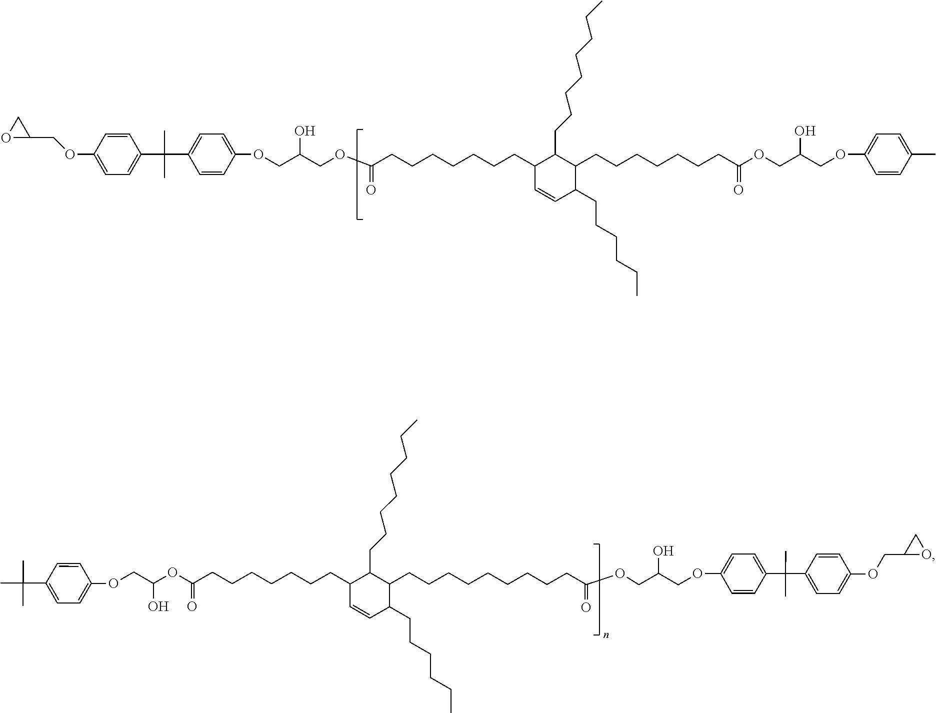

and B-tough™ C2x after carbonation:

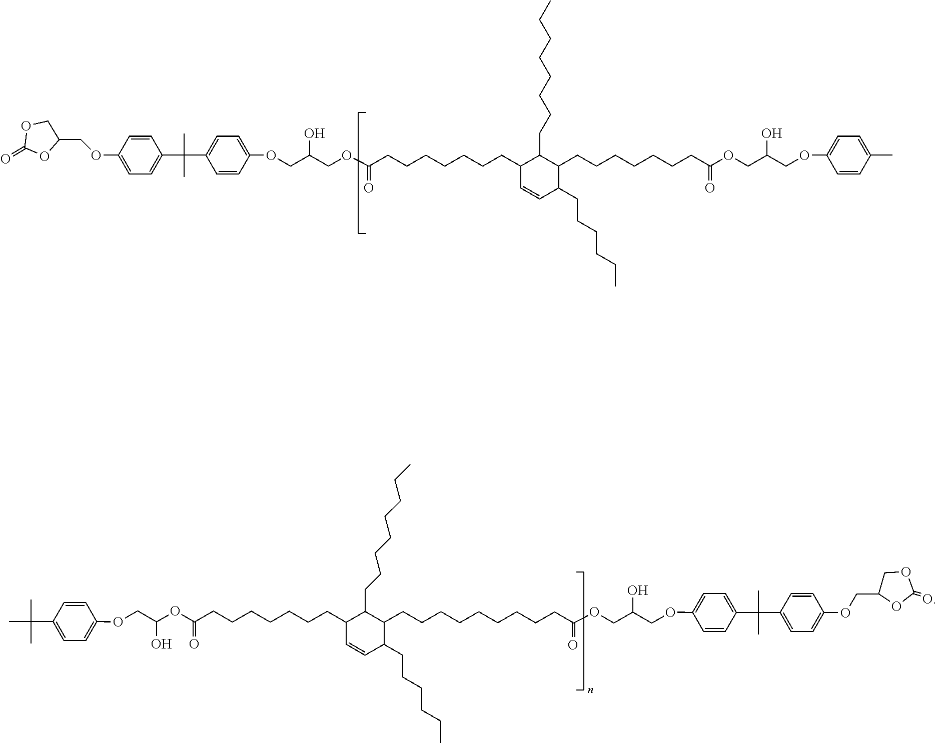

### Carboxylic Acid Monomer

Carboxylic acid is an organic acid that contains a carboxyl group (—COOH) attached to a substituted or unsubstituted hydrocarbon group. In order to prepare amidated prepolymers, carboxylic acid monomers used in this application contain at least two carboxylic groups, esters, halides or anhydrides thereof. The carboxylic acid monomer contemplated may include, without limitation, dimer acids and trimer acids. The substituted or unsubstituted hydrocarbon group that the carboxyl group is attached to may contain both aliphatic and aromatic molecular fragments, and the aliphatic molecular fragments may include further linear, branched, and cyclic fragments. The hydrocarbon group may be substituted with heteroatoms such as N, S, and O or other substituents as described above.

In some embodiments, the carboxylic acid monomer is a dimer acid. As used herein, the term “dimer acid”, also known as “dimerized fatty acid” or “dimer fatty acid”, refers to a dicarboxylic acid prepared by dimerization of unsaturated fatty acids. Preferred unsaturated fatty acids for dimerization include unsaturated C₁₂ to C₂₂ fatty acids. Depending on the number and position of the double bonds in the C₁₂ to C₂₂ fatty acids used for preparing the dimer fatty acids, the carboxyl groups of the dimer fatty acids are joined to one another by hydrocarbon moieties having predominantly 24 to 44 carbon atoms. These hydrocarbon moieties are commonly branched and may contain double bonds, C₆₋₁₀ cycloaliphatic hydrocarbon moieties, or C₆₋₁₀ aromatic hydrocarbon moieties; these cycloaliphatic moieties and/or these aromatic moieties may also be fused.

In preferred embodiments, the carboxylic acid monomer is a dimer acid of a fatty acid comprising from 8 to 22, preferably 12 to 20 carbon atoms and most preferably 14-18 carbon atoms. In yet other preferred embodiments, the carboxylic acid monomer is a dimer acid of two different fatty acids each comprising from 8 to 22, preferably 12 to 20 carbon atoms and most preferably 14-18 carbon atoms. In additional embodiments, the carboxylic acid monomer is a trimer acid of a fatty acid comprising from 8 to 22, preferably 12 to 20 carbon atoms and most preferably 14-18 carbon atoms; or a trimer acid of two different fatty acids each comprising from 8 to 22, preferably 12 to 20 carbon atoms and most preferably 14-18 carbon atoms; or a trimer acid of three different fatty acids each comprising from 8 to 22, preferably 12 to 20 carbon atoms and most preferably 14-18 carbon atoms. Examples of fatty acid used for dimerization or trimerization include oleic acid, linoleic acid, α-linolenic acid, and 7-linolenic acid.

Examples of preferred dimer acids used in this application include the compounds sold under the brand names Pripol™ 1006, Pripol™ 1009, Pripol™ 1012, Pripol™ 1013, Pripol™ 1017, Pripol™ 1022 VEG, Pripol™ 1025 and B-tough® from Croda; Radiacid® 0970, Radiacid® 0971, Radiacid® 0972, Radiacid® 0975, Radiacid® 0976, and Radiacid® 0977 from Oleon; Empol® 1008, Empol® 1061, and Empol® 1062 from BASF; and Unidyme® 10 and Unidyme® TI from Arizona Chemical.

Examples of preferred trimer acids used in this application include Pripol™ 1027 and Pripol™ 1040.

In additional embodiments, the carboxylic acid monomer is an aliphatic dicarboxylic acid comprising 6-36 carbons. In preferred embodiments, the carboxylic acid monomer is an aliphatic dicarboxylic acid comprising 8-32 carbons. In more preferred embodiments, the carboxylic acid monomer is an aliphatic dicarboxylic acid comprising 14-24 carbons. In yet other more preferred embodiments, the carboxylic acid monomer is an aliphatic dicarboxylic acid comprising 10-20 carbons.

Non-limiting examples of aliphatic dicarboxylic acid include octanedioic acid, nonanedioic acid, decanedioic acid, undecanedioic acid, dodecanedioic acid, tridecanedioic acid, tetradecanedioic acid, pentadecanedioic acid, hexadecanedioic acid, heptadecanedioic acid, octadecanedioic acid, nonadecanedioic acid, eicosanedioic acid, henicosanedioic acid, docosanedioic acid, tricosanedioic acid, tetracosanedioic acid, pentacosanedioic acid, hexacosanedioic acid, heptacosanedioic acid, octacosanedioic acid, nonacosanedioic acid, nonodecanoic acid, triacontanedioic acid, hentriacontanedioic acid, 2,6-didodecylheptanedioic acid, and 2-octacosylpropanedioic acid. Non-limiting examples of aliphatic dicarboxylic acid include suberic acid (i.e., octanedioic acid, 1,8-octanedioic acid, octanedioic acid, octane-1,8-dioic acid, 1,6-hexanedicarboxylic acid, capryllic diacids), sebacic acid (i.e., 1,10-decanedioic acid, decanedioic acid, decane-1,10-dioic acid, 1,8-octanedicarboxylic acid, capric diacid), dodecanedioic acid (i.e., 1,12-dodecanedioic acid, dodecanedioic acid, dodecane-1,12-dioic acid, 1,10-decanedicarboxylic acid, decamethylenedicaboxylic acid, 1,10-dicarboxydecane, lauric diacid), tetradecanedioic acid (i.e., 1,14-tetradecanedioic acid, tetradecanedioic acid, tetradecane-1,14-dioic acid, 1,12-dodecanedicarboxylic acid, myristic diacid), thapsic acid (i.e., hexadecanedioic acid, 1,16-hexadecanedioic acid, hexadecanedioic acid, hexadecane-1,16-dioic acid, 1,14-tetradecanedicarboxylic acid, palmitic diacid), cis-9-hexadecenedioic acid (i.e., palmitoleic diacids), octanedioic acid (i.e., 1,18-octadecanedioic acid, octadecanedioic acid, octadecane-1,18-dioic acid, 1,16-hexadecanedicarboxylic acid, stearic diacid), cis-9-octadecenedioic acid (i.e., oleic diacids), cis-9,12-octadecenedioic acid (i.e., linoleic diacids), cis-9,12,15-octadecenedioic acid (i.e., linolenic diacids), arachidic diacid (i.e., eicosanoic diacid, icosanoic diacid), 11-eicosenoic diacid (i.e., cis-11-eicosenedioic acid), 13-eicosenoic diacids (i.e., cis-13-eicosenedioic acid), arachidonic diacid (i.e., cis-5, 8, 11,14-eicosatetraenedioic acid).

Provided in Table 1 are nonlimiting representative carboxylic acid monomers used in this application.

TABLE 1

| # | Structure |
|---|---|
| A1 | 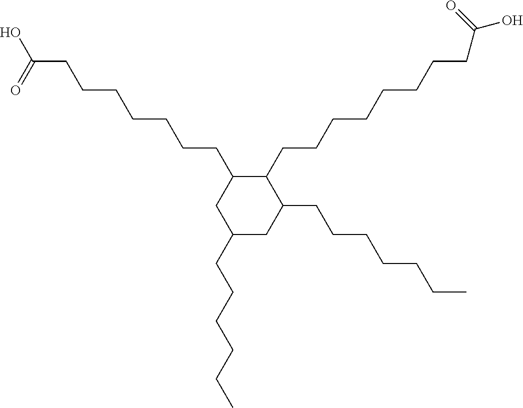 [SMILES: CCCCCCCC1CC(CCCCCC)CC(CCCCCCCC(=O)O)C1CCCCCCCCC(=O)O] |
| | Pripol ™ 1009 |
| A2 | 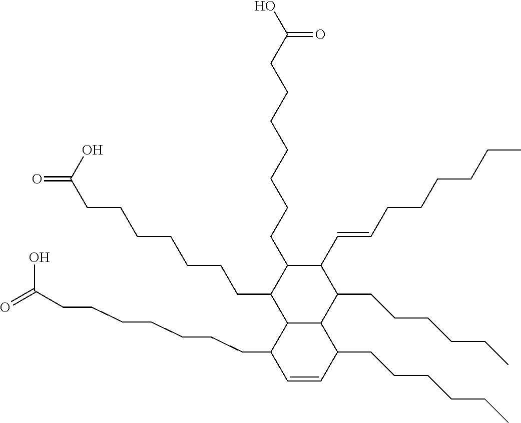 [SMILES: CCCCCC/C=C/C1C(CCCCCCCC(=O)O)C(CCCCCCCC(=O)O)C2C(CCCCCCCC(=O)O)C=CC(CCCCCC)C2C1CCCCCC] |
| | Pripol ™ 1027 |
| A3 | 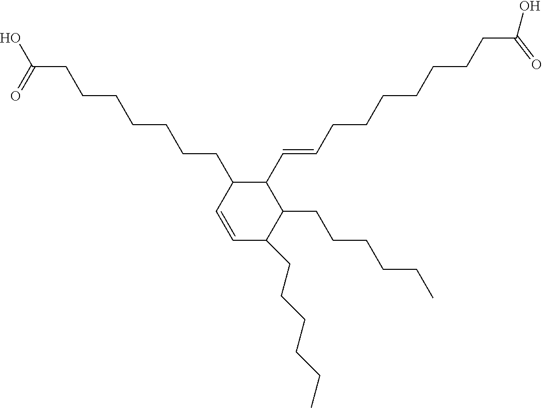 [SMILES: CCCCCCC1C=CC(CCCCCCCC(=O)O)C(/C=C/CCCCCCCC(=O)O)C1CCCCCC] |
| A4 | 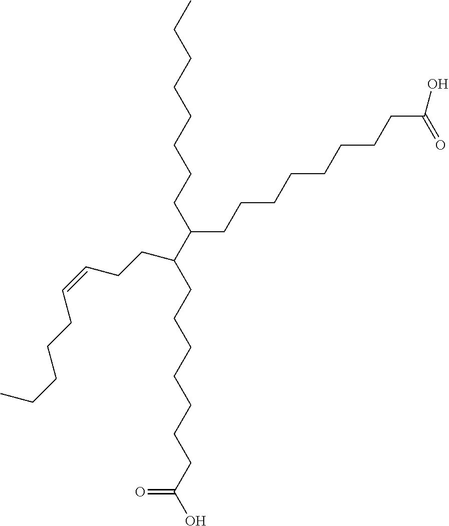 [SMILES: CCCCC/C=C\CCC(CCCCCCCC(=O)O)C(CCCCCCCC)CCCCCCCCC(=O)O] |
| A5 | 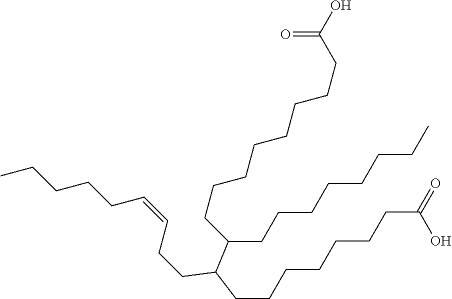 [SMILES: CCCCC/C=C\CCC(CCCCCCCC(=O)O)C(CCCCCCCC)CCCCCCCCC(=O)O] |

In some preferred embodiments, the carboxylic acid monomer is represented by Formula (I):

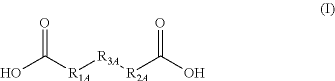

Wherein R_{1A} and R_{2A} are each independently selected from the group consisting of substituted or unsubstituted C₁-C₂₃ alkane moieties, substituted or unsubstituted C₂-C₂₃ alkene moieties, and substituted or unsubstituted C₂-C₂₃ alkyne moieties; and R_{3A} is absent or a hydrophobic hydrocarbon group —CH(R³¹)CH(R³²). —R³¹ and R³² are each independently selected from a substituted or unsubstituted C₁-C₂₄ alkyl, a substituted or unsubstituted C₂-C₂₄ alkenyl, and a substituted or unsubstituted C₂-C₂₄ alkynyl. Or R³¹ and R³² together with the carbons they are attached to form a substituted C₆-C₁₀ cycloaliphatic hydrocarbon group or a substituted C₆ aromatic hydrocarbon group, and the C₆-C₁₀ cycloaliphatic hydrocarbon groups and/or the C₆ aromatic hydrocarbon groups can also be optionally fused, wherein the substituents on the cycloaliphatic hydrocarbon group and/or on the aromatic hydrocarbon group are independently selected from a substituted or unsubstituted C₄-C₁₂ alkyl, a substituted or unsubstituted C₄-C₁₂ alkenyl, and a substituted or unsubstituted C₄-C₁₂ alkynyl.

Substituents for each moiety can include any group or moiety which does not prevent or substantially interfere with the reaction of a cyclic carbonate and amine. The ability of a moiety to prevent the reaction of a cyclic carbonate and amine can be readily established empirically. As above, The term “substituted” refers to substitution by independent replacement of one, two, or three or more of the hydrogen atoms with substituents including, but not limited to, —F, —C₁, —Br, —I, —OH, C₁-C₁₂-alkyl; C₂-C₁₂-alkenyl, C₂-C₁₂-alkynyl, —C₃-C₁₂-cycloalkyl, protected hydroxy, —NO₂, —N₃, —CN, —NH₂, protected amino, oxo, thioxo, —NH—C₁. C₁₂-alkyl, —NH—C₂-C₅-alkenyl, —NH—C₂-C₅-alkynyl, —NH—C₃-C₁₂-cycloalkyl, —NH-aryl, —NH— heteroaryl, —NH-heterocycloalkyl, -dialkylamino, -diarylamino, -diheteroarylamino, —O—C₁. C₁₂-alkyl, —O—C₂-C₈-alkenyl, —O—C₂-C₈-alkynyl, —O—C₃-C₁₂-cycloalkyl, —O-aryl, —O-heteroaryl, —O-heterocycloalkyl, —C(O)—C₁-C₁₂-alkyl, —C(O)—C₂-C₅-alkenyl, —C(O)—C₂-C₈-alkynyl, —C(O)—C₃-C₁₂-cycloalkyl, —C(O)-aryl, —C(O)-heteroaryl, —C(O)-heterocycloalkyl, —CONH₂, —CONH—C₁-C₁₂-alkyl, —CONH—C₂-C₅-alkenyl, —CONH—C₂-C₈-alkynyl, —CONH—C₃-C₁₂-cycloalkyl, —CONH-aryl, —CONH-heteroaryl, —CONH-heterocycloalkyl, —OCO₂-C₁-C₁₂-alkyl, —OCO₂-C₂-C₈-alkenyl, —OCO₂-C₂-C₈-alkynyl, —OCO₂-C₃-C₁₂-cycloalkyl, —OCO₂-aryl, —OCO₂-heteroaryl, —OCO₂-heterocycloalkyl, —CO₂-C₁-C₁₂ alkyl, —CO₂-C₂-C₈ alkenyl, —CO₂-C₂-C₈ alkynyl, CO₂—C₃-C₁₂-cycloalkyl, —CO₂-aryl, CO₂-heteroaryl, CO₂-heterocyloalkyl, —OCONH₂, —OCONH—C₁C₁₂-alkyl, —OCONH—C₂-C₅-alkenyl, —OCONH—C₂-C₈-alkynyl, —OCONH—C₃-C₁₂-cycloalkyl, —OCONH-aryl, —OCONH-heteroaryl, —OCONH-heterocyclo-alkyl, —NHC(O)H, —NHC(O)—C₁. C₁₂-alkyl, —NHC(O)—C₂-C₅-alkenyl, —NHC(O)—C₂-C₅-alkynyl, —NHC(O)—C₃-C₁₂-cycloalkyl, —NHC(O)-aryl, —NHC(O)-heteroaryl, —NHC(O)-heterocyclo-alkyl, —NHCO₂-C₁-C₁₂-alkyl, —NHCO₂-C₂-C₅-alkenyl, —NHCO₂-C₂-C₈-alkynyl, —NHCO₂-C₃-C₁₂-cycloalkyl, —NHCO₂-aryl, —NHCO₂-heteroaryl, —NHCO₂— heterocycloalkyl, —NHC(O)NH₂, —NHC(O)NH—C₁-C₁₂-alkyl, —NHC(O)NH—C₂-C₅-alkenyl, —NHC(O)NH—C₂-C₅-alkynyl, —NHC(O)NH—C₃-C₁₂-cycloalkyl, —NHC(O)NH-aryl, —NHC(O)NH-heteroaryl, —NHC(O)NH-heterocycloalkyl, NHC(S)NH₂, —NHC(S)NH—C₁-C₁₂-alkyl, —NHC(S)NH—C₂-C₅-alkenyl, —NHC(S)NH—C₂-C₅-alkynyl, —NHC(S)NH—C₃-C₁₂-cycloalkyl, —NHC(S)NH-aryl, —NHC(S)NH-heteroaryl, —NHC(S)NH— heterocycloalkyl, —NHC(NH)NH₂, —NHC(NH)NH—C₁-C₁₂-alkyl, —NHC(NH)NH—C₂-C₅-alkenyl, —NHC(NH)NH—C₂-C₅-alkynyl, —NHC(NH)NH—C₃-C₁₂-cycloalkyl, —NHC(NH)NH-aryl, —NHC(NH)NH-heteroaryl, —NHC(NH)NH-heterocycloalkyl, —NHC(NH)—C₁-C₁₂-alkyl, —NHC(NH)—C₂-C₅-alkenyl, —NHC(NH)—C₂-C₅-alkynyl, —NHC(NH)—C₃-C₁₂-cycloalkyl, —NHC(NH)-aryl, —NHC(NH)-heteroaryl, —NHC(NH)-heterocycloalkyl, —C(NH)NH—C₁-C₁₂-alkyl, —C(NH)NH—C₂-C₅-alkenyl, —C(NH)NH—C₂-C₅-alkynyl, —C(NH)NH—C₃-C₁₂-cycloalkyl, —C(NH)NH-aryl, —C(NH)NH-heteroaryl, —C(NH)NH-heterocycloalkyl, —S(O)—C₁-C₁₂-alkyl, —S(O)—C₂-C₅-alkenyl, —S(O)—C₂-C₅-alkynyl, —S(O)—C₃-C₁₂-cycloalkyl, —S(O)-aryl, —S(O)— heteroaryl, —S(O)-heterocycloalkyl, —SO₂NH₂, —SO₂NH—C₁-C₁₂-alkyl, —SO₂NH—C₂-C₅-alkenyl, —SO₂NH—C₂-C₈-alkynyl, —SO₂NH—C₃-C₁₂-cycloalkyl, —SO₂NH-aryl, —SO₂NH-heteroaryl, —SO₂NH-heterocycloalkyl, —NHSO₂-C₁-C₁₂-alkyl, —NHSO₂-C₂-C₅-alkenyl, —NHSO₂-C₂-C₈-alkynyl, —NHSO₂-C₃-C₁₂-cycloalkyl, —NHSO₂-aryl, —NHSO₂-heteroaryl, —NHSO₂— heterocycloalkyl, —CH₂NH₂, —CH₂SO₂CH₃, -aryl, -arylalkyl, -heteroaryl, -heteroarylalkyl, -heterocycloalkyl, —C₃-C₁₂-cycloalkyl, polyalkoxyalkyl, polyalkoxy, -methoxymethoxy, -methoxyethoxy, —SH, —S—C₁-C₁₂-alkyl, —S—C₂-C₈-alkenyl, —S—C₂-C₈-alkynyl, —S—C₃-C₁₂-cycloalkyl, —S-aryl, —S-heteroaryl, —S-heterocycloalkyl, or methylthio-methyl. In certain embodiments, the substituents are independently selected from halo, preferably C₁ and F; C₁. C₄-alkyl, preferably methyl and ethyl; halo-C₁-C₄-alkyl, such as fluoromethyl, difluoromethyl, and trifluoromethyl; C₂-C₄-alkenyl; halo-C₂-C₄-alkenyl; C₃-C₆-cycloalkyl, such as cyclopropyl; C₁-C₄-alkoxy, such as methoxy and ethoxy; halo-C₁-C₄-alkoxy, such as fluoromethoxy, difluoromethoxy, and trifluoromethoxy; acetyl; —OH; NH₂; C₁-C₄-alkylamino; di(C₁-C₄-alkyl)amino; and NO₂. It is understood that the aryls, heteroaryls, alkyls, and the like can be further substituted. In some cases, each substituent in a substituted moiety is additionally optionally substituted with one or more groups, each group being independently selected from C₁-C₄-alkyl; —CF₃, —OCH₃, —OCF₃, —F, —C₁, —Br, —I, —OH, —NO₂, and —NH₂.

Preferred substituents on the cycloaliphatic hydrocarbon radical and/or on the aromatic hydrocarbon radical, R_{3A}, are independently selected from a substituted or unsubstituted C₄-C₂₄ alkyl, a substituted or unsubstituted C₄-C₂₄ alkenyl, and a substituted or unsubstituted C₄-C₂₄ alkynyl. Such compounds embrace or mimic dimerized fatty acids. Without being bound by theory, it is possible that the cycloaliphatic and/or aromatic rings may provide chemical structures that facilitate orientation, aggregation or self-assembly of the product.

In some embodiments, R_{1A} and R_{2A} are each independently unsubstituted C₄-C₁₇ alkane moieties and unsubstituted C₄-C₁₇ alkene moieties, preferably C₄-C₁₂ alkane moieties and unsubstituted C₄-C₁₂ alkene moieties; and R_{3A} is absent.

In some preferred embodiments, R_{1A} and R_{2A} are each independently unsubstituted C₄-C₉ alkane moieties and unsubstituted C₄-C₉ alkene moieties, and R_{3A} is —CH(R³¹)CH(R³²)—. R³¹ and R³² are each independently selected from an unsubstituted C₄-C₉ alkyl, an unsubstituted C₄-C₉ alkenyl, and an unsubstituted C₄-C₉ alkynyl.

In other preferred embodiments, R_{1A} and R_{2A} are each independently unsubstituted C₄-C₉ alkane moieties and unsubstituted C₄-C₉ alkene moieties, and R_{3A} is substituted C₆-C₁₀ cycloaliphatic hydrocarbon radical or substituted C₆ aromatic hydrocarbon moieties. These C₆-C₁₀ cycloaliphatic moieties and/or these C₆ aromatic moieties may also be fused. The substituents on the C₆-C₁₀ cycloaliphatic hydrocarbon radical and/or on the C₆ aromatic hydrocarbon radical are independently selected from a substituted or unsubstituted C₄-C₉ alkyl, a substituted or unsubstituted C₄-C₉ alkenyl, and a substituted or unsubstituted C₄-C₉ alkynyl. Preferably, R_{3A} is substituted C₆, C₇, or C₈ cycloaliphatic hydrocarbon radical or substituted C₆ aromatic hydrocarbon moieties; and the substituents on the C₆, C₇, or C₈ cycloaliphatic hydrocarbon radical and/or on the C₆, aromatic hydrocarbon radical are independently selected from an unsubstituted C₅-C₉ alkyl, an unsubstituted C₅-C₉ alkenyl, and an unsubstituted C₅-C₉ alkynyl.

In some preferred embodiments, the carboxylic acid monomer is Pripol™ 1009.

### Amine Monomer

To prepare amidated prepolymers, amine monomer used in this application at least two primary amine (—NH₂) groups attached to a substituted or unsubstituted hydrocarbon group which preferably contains 2 to 20 carbons. The substituted or unsubstituted hydrocarbon group that—NH₂ are attached to may contain both aliphatic and aromatic molecular fragments, and the aliphatic molecular fragments may include further linear, branched, and cyclic fragments. These cycloaliphatic fragments and/or these aromatic fragments may also be fused. The hydrocarbon group may be substituted with heteroatoms such as N, S, and O.

In some preferred embodiments, the amine monomer used in this application contains 4 to 14 carbons.

In some preferred embodiments, the amine monomer used in this application is a diamine or triamine. In even more preferred embodiments, the amine monomer used in this application is a diamine.

In some embodiments, the diamine monomer include, without limitation, butane diamine, pentane diamine, hexane diamine, heptane diamine, octane diamine, nonane diamine, decane diamine, undecane diamine, dodecane diamine, tridecane diamine, tetradecane diamine, pentadecane diamine, hexadecane diamine, and xylenediamine. The diamines can also bio-based and can include decarboxylated amino acids, such as cadaverine (CA).

TABLE 2
provides nonlimiting representative examples of diamine that
can be used in this application.

| # | Structure |
|---|---|
| D1 | 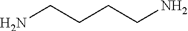 |
| | 1,4-butanediamine (BDA) |
| D2 | 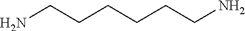 |
| | 1,6-hexanediamine (HDA) |
| D3 | 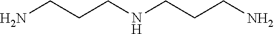 |
| | Norspermidine (NSD) |
| D4 | 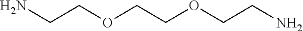 |
| | Triethylene glycol diamine |
| D5 | 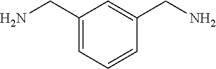 |
| | m-xylenediamine (MXDA) |
| D6 | 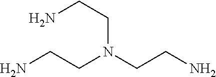 |
| | Tris(2-aminoethyl)amine (TAEA) |
| D7 | 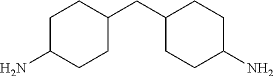 [SMILES: NC1CCC(CC2CCC(N)CC2)CC1] |
| | 4,4 Diaminodicyclohexylmethane |
| | (PACM) |
| D8 | 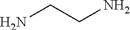 |
| | Ethane diamine (EDA) |

In some preferred embodiments, the amine monomer used in this application is a diamine, and the diamine monomer is 1,4-butanediamine (BDA) or 1,6-hexanediamine (HDA).

In some embodiment, the diamine monomer can be represented by Formula (II):

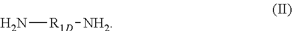

R_{1D} is selected from substituted or unsubstituted C₂-C₂₀ alkane radical, substituted or unsubstituted C₂-C₂₀ alkene radical, substituted or unsubstituted C₂-C₂₀ alkyne radical, substituted or unsubstituted C₆-C₁₀ cycloaliphatic hydrocarbon radical (preferably, substituted C₆ cycloaliphatic hydrocarbon radical), or substituted or unsubstituted C₆ aromatic hydrocarbon radical; the cycloaliphatic hydrocarbon radical and/or aromatic hydrocarbon radical can be optionally fused. Preferably, R_{1D} is an unsubstituted C₄-C₈ alkane radical. Most preferably, R_{1D} is —(CH₂)₄— or —(CH₂)₆—.

In preferable embodiments, the amine monomer is 1,4-butane diamine (BDA) or 1,6-hexanediamine (HDA). In an alternative embodiment, the diamine can have the chemical structure of the dimerized fatty acids wherein the amine replaces the carboxyl group. Such molecules are sold under the tradename Priamine® by Croda. Therefore, the diamine can have the formula:

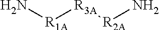

Wherein R^{1A}, R_{2A} and R_{3A} are defined above.

### Amidated Prepolymer

To obtain the amide-urethane macromolecule of this invention, an amidated prepolymer can be used as a polymer precursor. The amidated prepolymer can be prepared by reacting the carboxylic acid monomer and the amine monomer as described herein. As used herein, the term “prepolymer” is referred to a system of monomers that have been reacted to an intermediate-molecular mass state and the system is capable of further polymerization by reactive groups to a fully cured, high-molecular-mass state.

Unlike the products from the traditional polyamidation of diamine and diacid having—NH₂ group at one chain end and —COOH group at the other, the amidated prepolymer has an excess of the end group of NH₂ to optimize the urethanization (carbamation) of the prepolymer with a cyclic carbonate monomer in the next step. Therefore, amine monomers can be added in overstoichiometric amount relative to the carboxylic acid monomer during amidation. For example, since both diamine and dimer acid have a functionality of 2 (i.e., the number of polymerizable groups is 2), when reacted with each other, the molar ratio of diamine monomer to dimer acid monomer is at least 1, such as at least about 2, at least about 3, at least about 5, or at least about 10 or more. Any unreacted diamine monomers can be subsequently removed after the amidation reaction. In some preferred embodiments, the molar ratio of amine monomer to acid monomer is about 2 to about 20, about 3 to about 15, more preferably, about 5 to about 10. In some preferred embodiments, the molar ratio of diamine monomer to dimer acid monomer (diamine:dimer acid) is 10.

To facilitate the polyurethanization in the next step, the amidated prepolymer preferably has a controlled chain length. In some embodiments, the amidated prepolymer has the number of repeating units between about 1 to about 20. In some embodiments, the amidated prepolymer has the number of repeating units between about 2 to about 15. In some embodiments, the amidated prepolymer has the number of repeating units between about 1 to about 10. In some embodiments, the amidated prepolymer has the number of repeating units between about 2, about 3, about 4, about 5, about 6, about 7, about 8, and about 9. In some embodiments, the amidated prepolymer has the number of repeating units between about 2, about 3, about 4, and about 5.

As an example, the amidated prepolymer can be prepared using methods analogous to the following general synthetic scheme:

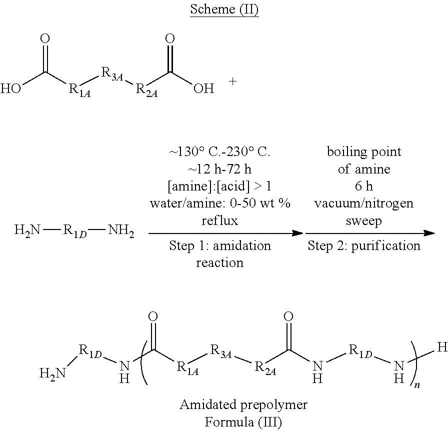

All the variables, R_{1A}, R_{2A}, R_{3A}, and R_{1D}, are defined as above, including all preferrable and alternative embodiments. n refers to the number of repeating units in amidated prepolymer and is from about 1 to about 10, preferably, about 1 to about 6. In some embodiments, n is about 1, about 2, about 3, about 4, or about 5. In some embodiments, n is about 1. In some embodiments, n is about 2. In some embodiments, n is about 3. In some embodiments, n is about 4. In some embodiments, n is about 5. Since the resultant amidated prepolymer from the reaction can be a mixture of a range of chain lengths, n as the averaged value of repeating unit of the mixture may or may not be an integer, e.g., n can be 4 or 4.2.

During the amidation reaction, molar ratio of amine/carboxylic acid, reaction time, and temperature can be varied to achieve a target degree of polymerization or n. After the reaction, the excess amine and water can be removed by vacuum distillation and/or by use of a nitrogen sweep. Weight average molecular weight and primary amine equivalent weight (PAEW) of the resultant amidated prepolymer can be determined. The primary amine equivalent weight (PAEW) used in this application is titrated using HCl solution according to ASTM D2074 as published as of the filing date of the application.

In some preferred embodiments, when R_{1D} contains no more than 8 carbons, R_{1A} and R_{2A} are each independently unsubstituted C₄-C₉ alkane moieties and unsubstituted C₄-C₉ alkene moieties, and R_{3A} is —CH(R³¹)CH(R³²)—, wherein R³¹ and R³² are each independently selected from an unsubstituted C₅-C₉ alkyl and an unsubstituted C₅-C₉ alkenyl, or R³¹ and R³² together with the carbons they are attached to form a substituted C₆-C₁₀ cycloaliphatic hydrocarbon group or a substituted C₆ aromatic hydrocarbon group, and the C₆-C₁₀ cycloaliphatic hydrocarbon groups and/or the C₆ aromatic hydrocarbon groups can also be optionally fused, wherein the substituents on the cycloaliphatic hydrocarbon group and/or on the aromatic hydrocarbon group are independently selected from a substituted or unsubstituted C₄-C₁₂ alkyl, a substituted or unsubstituted C₄-C₁₂ alkenyl, and a substituted or unsubstituted C₄-C₁₂ alkynyl. The resultant amidated prepolymer has relatively polar fragments of —C(O)NHR_{1D}NH₂ at both chain ends, and relatively nonpolar fragment —R_{1A}R_{3A}R_{2A}— alternating with the more polar group —C(O)NHR_{1D}NHC(O)— on the prepolymer backbone. The resultant amidated prepolymer can undergo microphase or nanophase separation due to the difference in polarities of different domains, which enhances the resilience and flexibility of the amide-urethane macromolecule thereof.

In other preferred embodiments, when R_{1D} contains no more than 8 carbons, R_{1A} and R_{2A} are each independently unsubstituted C₄-C₉ alkane moieties and unsubstituted C₄-C₉ alkene moieties, and R_{3A} is a substituted C₆, C₇, or C₈ cycloaliphatic hydrocarbon radical or a substituted C₆ aromatic hydrocarbon radical; and the substituents on the C₆, C₇, or C₈ cycloaliphatic hydrocarbon radical and/or on the C₆, aromatic hydrocarbon radical are independently selected from an unsubstituted C₅-C₉ alkyl and an unsubstituted C₅-C₉ alkenyl, the resultant amidated prepolymer has hydrophilic fragments of —C(O)NHR_{1D}NH₂ at both chain ends, and hydrophobic fragment —R_{1A}R_{3A}R_{2A}— alternating with the hydrophilic group —C(O)NHR_{1D}NHC(O)— on the prepolymer backbone. The resultant amidated prepolymer is amphiphilic.

In some preferred embodiments, when R_{1D} contains no more than 8 carbons, the carboxylic acid monomer is selected from Table 1, the resultant amidated prepolymer is amphiphilic. In some preferred embodiments, when the amine monomer is 1,4-butane diamine (BDA), the carboxylic acid monomer is any one of those listed in Table 1, the resultant amidated prepolymer is amphiphilic. In additional preferred embodiments, when the amine monomer is 1,6-hexanediamine (HDA), the carboxylic acid monomer is any one of those listed in Table 1, the resultant amidated prepolymer is amphiphilic.

The amidated prepolymer can be prepared using any one of carboxylic acid monomers as described herein and any one of amine monomers as described herein. In some preferred embodiments, when the amine monomer is any one of those listed in Table 2, the carboxylic acid monomer is any one of those listed in Table 1, and the resultant amidated prepolymer is amphiphilic. In some preferred embodiments, when the amine monomer is any one of those listed in Table 2, the carboxylic acid monomer is Pripol™ 1009, the resultant amidated prepolymer is amphiphilic.

As a nonlimiting example, when amine monomer is BDA and the carboxylic acid monomer is Pripol™ 1009, the resultant amidated prepolymer is amphiphilic and can have the following structure:

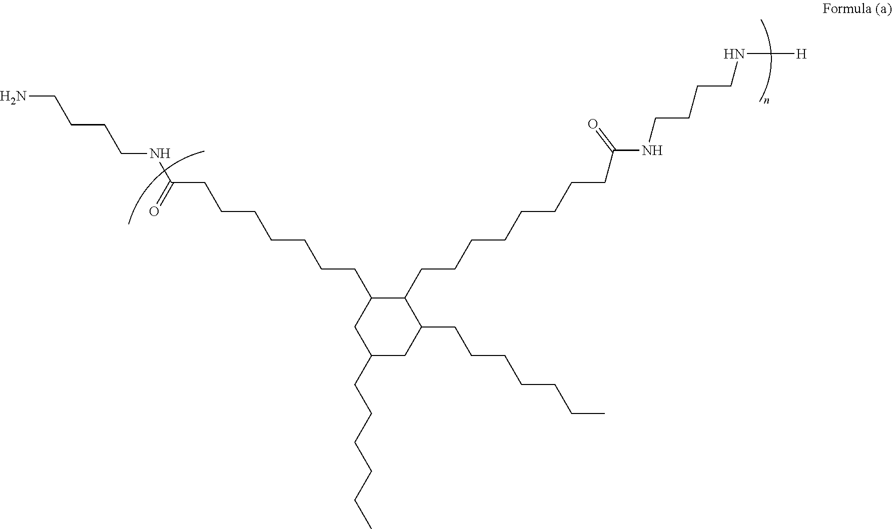

Wherein n is a number between 1 and 10, for example, preferably 1, 2, 3 or 4.

The reaction of BDA and Pripol™ 1009 can be conducted at a reaction temperature at about 180° C. for 12-72 hours, under reflux. The reaction is aliquoted for primary amine analysis over the course of the reaction to produce an amidated prepolymer having a relatively low weight average molecular weight between about 710 g/mol and about 2600 g/mol, with a primary amine equivalent weight (PAEW) between about 350 and about 1300. Maintaining a molecular weight in this range provides an amidated prepolymer having a low melting temperature, e.g., between about 10° C. and about 90° C., and facilitates further urethanization in the next step. Each resultant prepolymer derived from CC3 and amine is named by the amine monomer and its PAEW, e.g., when the amine monomer is BDA and PAEW is 1300, the prepolymer is BDA1300.

In reference to Formula (a), Table 3 provides representative examples of amidated prepolymers from BDA and Pripol™ 1009 with different chain lengths together with the melting temperatures and viscosities thereof.

TABLE 3

| Amidated | | | | Viscosity |
|---|---|---|---|---|
| prepolymer | (# of repeat | | Melting | @ 85° C. |
| # | units) | MW | T (° C.) | (Pa · sec) |
| BDA450 | 1.3 | 900 | 39 | 2.5 |
| BDA530 | 1.6 | 1060 | NA | NA |
| BDA850 | 2.7 | 1700 | 72 | 16.3 |
| BDA1300 | 4.2 | 2600 | 82 | 79.5 |

Additional prepolymers can be derived from BDA and Pripol™ 1009 by varying the molar ratio of BDA/Pripol™ 1009 and thus the resultant chain length, such as BDA350 with n of about 1.

Other diamines can be used in the place of BDA, such as EDA, HAD, MXDA, NSD as listed in Table 2. The result prepolymers are named by their PAEW measured per ASTM D2074, e.g., EDA400, HDA450, MXDA350, and NSD350.

Similarly, a variety of amidated prepolymers for making amide-urethane macromolecules can be prepared by reacting any one of the amine monomers as described herein and any one of the carboxylic acid monomers as described herein, following the steps described in this section. By selecting specific amine monomers and specific carboxylic acid monomers and controlling the amidation reactions, the structure of amidated prepolymer and thus the structure and properties of amide-urethane macromolecule can be tailored. Another essential process that can further dictate the properties of amide-urethane macromolecule is the selection of cyclic carbonate monomer and the urethanization reaction in the next step.

Without being limited by theory, it is believed to be advantageous to create the amidated prepolymer by reacting a high molecular weight carboxylic acid monomer with a low molecular weight diamine. For the purposes of this discussion, a high molecular weight monomer is a molecule that has a molecular weight of at least about 300, preferably at least about 400, and a low molecular weight has a molecular weight of less than about 300, preferably less than about 200. Combining monomeric segments or repeat units in a highly ordered fashion with aliphatic, hydrophobic segments and amide bonds may facilitate self-assembly which encourages the advantageous mechanical properties achieved.

It is also believed that combining a low molecular weight carboxylic acid monomer and a high molecular diamine may also give rise to similar results. Similarly, the prepolymer can be made with reverse amides, which is intended to be included within the inventions herein. Thus, the term “reverse amide” when used in conjunction with the prepolymer is intended to embrace the structure where the —CONH— is replaced with —NHCO—.

### Amide-Urethane Macromolecule

The cyclic carbonate monomers and the amidated prepolymers as described above are reacted with each other via urethanization reaction to form amide-urethane macromolecules of this invention. Since the cyclic carbonate monomers and the amidated prepolymers contain are joined together via urethane (i.e., carbamate) links, the macromolecules of this invention can be classified as non-isocyanate polyurethanes (NIPUs). In some embodiments, the term “NIPU” is used to refer to the macromolecules of this invention, as well as the comparator polymers synthesized using different starting materials. As defined above, the amidated prepolymer has —NH₂ groups at its chain ends, and the —NH₂ group can react with cyclic carbonate group to form the carbamate (urethane) bond. In some embodiments, the cyclic carbonate monomers contain two cyclic carbonate groups per molecule, i.e., they have a functionality of 2; the cyclic carbonate monomer and the amidated prepolymer upon reaction may result in an alternating copolymer. In some embodiments, the cyclic carbonate monomers contain three or more cyclic carbonate groups per molecules, i.e., they have a functionality of 3 or above; the cyclic carbonate monomer can play the role of crosslinker when reacting with the amidated prepolymer and result in a crosslinked macromolecule.

Given that there are three principal monomers as described in this application, the amide-urethane macromolecule can be prepared from one or more cyclic carbonate monomers, one or more amine monomers, and one or more carboxylic acid monomers. In some embodiments, the cyclic carbonate monomer is a carbonated triglyceride or a carbonated fatty acid ester, such as FAME. In some embodiments, the cyclic carbonate monomer is any one of CC2, CC3, carbonated RDGE, carbonated GE 21, carbonated GE 25, carbonated GE 31, and carbonated GE 61; the carboxylic acid monomer is any one of those listed in Table 1; and the amine monomer is any one of those listed in Table 2. In some preferred embodiments, the cyclic carbonate monomer is CC3, the carboxylic acid monomer is any one of those listed in Table 1, and the amine monomer is any one of those listed in Table 2. In some preferred embodiments, the cyclic carbonate monomer is CC3, the carboxylic acid monomer is any one of those listed in Table 1, and the amine monomer is any one of those listed in Table 2. In some preferred embodiments, the cyclic carbonate monomer is CC3, the carboxylic acid monomer is any one of those listed in Table 1, the amine monomer is any one of those listed in Table 2, and the number of repeating units of the amidated prepolymer is about 2 to about 10.

In some embodiments, the molar ratio of the amidated prepolymer to the cyclic carbonate monomer is about 0.5 to about 2. In some embodiments, the molar ratio of the amidated prepolymer to the cyclic carbonate monomer is about 1 to about 1.5. In some embodiments, the molar ratio of the amidated prepolymer to the cyclic carbonate monomer is about 1. In some embodiments, the molar ratio of the amidated prepolymer to the cyclic carbonate monomer is between about 1.5.

The amide-urethane macromolecule of this invention can be prepared using methods analogous to the following general synthetic scheme:

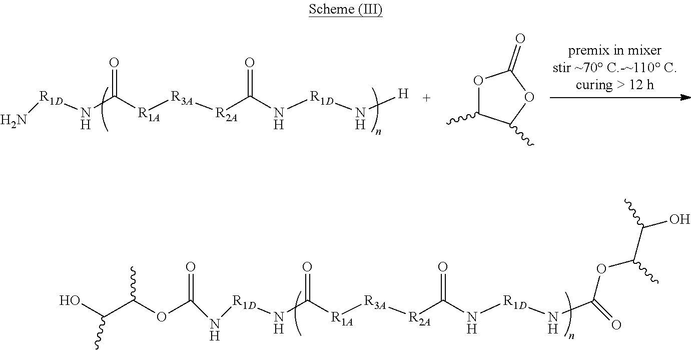

All the variables (R^{1A}, R_{2A}, R_{3A}, R_{1D}, and n) are defined as above, including all preferred and alternative embodiments. The reaction can be conducted in the following steps for example: cyclic carbonate monomers and amidated prepolymers are placed into a speedmixer jar (FlackTek, US), then the mixture is mixed at about 3000 rpm for about two minutes. The mixture is then stirred using a mechanical impeller or magnetic stir-bar at between about 10 rpm and about 1000 rpm at a temperature maintained between about 70° C. and about 110° C. for a period of time between about one minute and about 30 minutes. The resultant mixture is then poured into a polytetrafluoroethylene (PTFE) plate to prepare ASTM D638 type IV dumbbell-shaped samples. Thereafter, the liquid mixture in the mold is cured at a temperature between about 70° C. and about 110° C. for about 12 hours, followed by an additional curing step at about 110° C. for another 12 hours in a vacuum oven.

The amide-urethane macromolecule of this invention can be prepared using any one of these cyclic carbonate monomers as described herein and any one of these amidated prepolymers as described herein. Different combinations of cyclic carbonate monomers and amidated prepolymers (which themselves can be tailored by varying carboxylic acid monomers and amine monomers as described herein) allow the production of a variety of amide-urethane macromolecules with distinctive properties, which can include thermoplastic, thermoplastic elastomer, elastomer, thermoset, and vitrimer.

The term “vitrimer” as used herein refers to a permanent chemical network with dynamic covalent bonds that allow the network to change its topology while maintaining a constant number of chemical bonds in the system at all temperatures below degradation. Vitrimers are able to achieve a compelling balance of robust mechanical properties as a thermoset and processability as a thermoplastic. The term “dynamic covalent bond” is a class of covalent bonds that can undergo thermally activated bond exchange reactions, i.e., they can break and reform without irreversible side reactions at appropriate temperature. Dynamic covalent bonds are reversible and can rapidly reach thermodynamic equilibrium in response to a stimulus. In this application, the urethane bonds and the hydroxy bonds of the crosslinked amide-urethane macromolecule can serve as dynamic covalent bonds, enabling the crosslinked macromolecule to be processable as a vitrimer. (See Van Zee et al., Progress in Polymer Science, 2020, 104, 101233. https://doi.org/10.1016/j.progpolymsci.2020.101233) In some embodiments, the cyclic carbonate monomer contains two cyclic carbonate groups, such as CC2, carbonated RDGE, and carbonated GE 25, and the resultant amide-urethane macromolecule can be an alternating copolymer that comprises a segment derived from cyclic carbonate monomer and another segment derived from amidated prepolymer alternating with each other to form the backbone of the copolymer. For example, when the cyclic carbonate monomer is carbonated RDGE, the final product with reference to Scheme (III) can be:

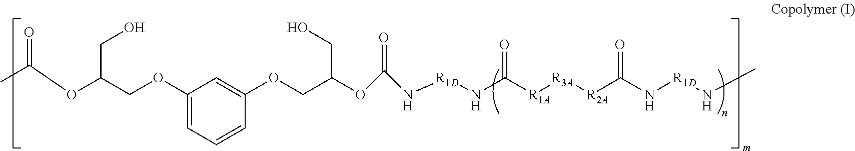

Copolymer (I) serves as one representative structure. The final product can contain compounds analogous to Copolymer (I), wherein the positions of a portion of —OH groups and a portion of —OC(O)-prepolymer segments are exchanged.

As another example, when the cyclic carbonate monomer is CC2, the final product with reference to Scheme (III) can be:

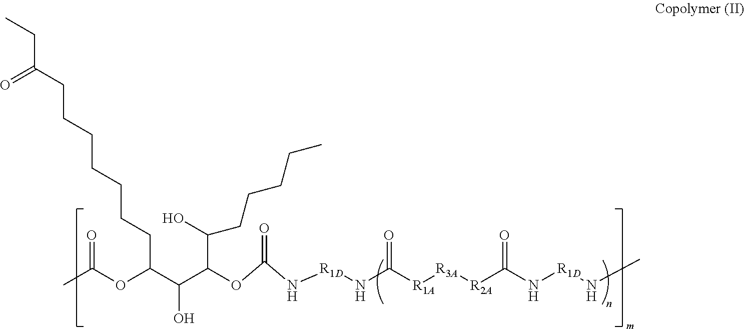

The variables (R_{1A}, R_{2A}, R_{3A}, R_{1D}, and n) are defined as above, including all preferred and alternative embodiments. m represents the number of repeating units in the final product and is about 50 to about 1000, preferably, about 50 to about 500. Since m is an averaged value, it may or may not be an integer. In some embodiments, m is about 50, about 60, about 70, about 80, about 90, about 100, about 150, about 200, about 250, about 300, about 350, about 400, about 450, or about 500. In some embodiments, m is about 100.

Copolymer (II) serves as one representative structure. The final product can contain compounds analogous to Copolymer (II), wherein the positions of a portion of —OH groups and a portion of —OC(O)-prepolymer segments are exchanged.

In some particular embodiments, the cyclic carbonate monomer contains two cyclic carbonate groups, and the resultant copolymer can be a thermoplastic elastomer. In some embodiments, the amidated prepolymer is amphiphilic, and the resultant copolymer may possess a two-phase microstructure due to incompatibility between the hydrophilic fragments from cyclic carbonate monomers and —NHR_{1D}NHC(O)—, and the hydrophobic fragments of —R_{1A}R_{3A}R_{2A}—. In some embodiments, preferably when n is >1, and R_{1A} and R_{2A} each contain at least four carbons, the resultant copolymer may go through microphase or nanophase separation, as —NHR_{1D}NH— (chain extender), and the urethane group on the backbone form hard segment domain, and the prepolymer is relatively more mobile and serves as soft segment domain. Upon uniaxial deformation, the soft segments are stretched, and the hard segments are reoriented and aligned and may further form hydrogen bonding, reducing the plastic flow of molecular chains. The resultant copolymer may behave like an elastomer upon uniaxial deformation.

In some embodiments, the cyclic carbonate monomer contains three cyclic carbonate groups, such as CC3 and carbonated GE31, and the resultant amide-urethane macromolecule is a crosslinked macromolecule. In some embodiments, the crosslinked macromolecule is a star shaped copolymer. With the functionality of the cyclic carbonate monomer equivalent to 3 (f=3) and the functionality of the amidated prepolymer equivalent to 2 (f=2), the stoichiometric ratio of cyclic carbonate monomer to amidated prepolymer is 2:3, and the cyclic carbonate monomer can serve as crosslinker in the resultant macromolecule. Based on the degree of crosslinking, the resultant crosslinked macromolecule may be a thermoset, a vitrimer, or an elastomer. In some embodiments, the resultant crosslinked macromolecule is a thermoset. In some embodiments, the resultant crosslinked macromolecule is a vitrimer. In some embodiments, the resultant crosslinked macromolecule is an elastomer.

In some preferred embodiments, the cyclic carbonate monomer is CC3, and the crosslinking effect of CC3 can be illustrated by the following structure:

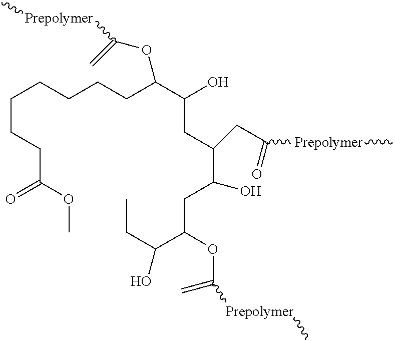

Representative structure of CC3 crosslinker in the crosslinked macromolecule, wherein the positions of a portion of —OH groups and a portion of —OC(O)-prepolymer segments can be exchanged.

The “Prepolymer” in the representative structure as shown above represents a segment derived from any one of these amidated prepolymers as described herein upon urethanization with CC3. In some embodiments, the other chain ends of the three “Prepolymer” segments that are not shown in the representative structure each are also covalently linked to a CC3 crosslinker, respectively. In some embodiments, the “Prepolymer” is a segment derived from an amidated prepolymer that is derived from any one of carboxylic acid monomers in Table 1 and any one of amine monomers in Table 2. In some preferred embodiments, the “Prepolymer” is a segment derived from Formula (III) in Scheme (II), wherein all the variables, R_{1A}, R_{2A}, R_{3A}, R_{1D}, and n, are defined as above, including all preferrable and alternative embodiments. In some preferred embodiments, the “Prepolymer” is a segment derived from an amidated prepolymer, wherein the amidated prepolymer is derived from any one of carboxylic acid monomers in Table 1 and either one of BDA and HDA in Table 2. In some preferred embodiments, the “Prepolymer” is a segment derived from any one of these amidated prepolymers in Table 3. In some cases, the “Prepolymer” is a segment derived from the prepolymer BDA450. In some cases, the “Prepolymer” is a segment derived from the prepolymer BDA530. In some cases, the “Prepolymer” is a segment derived from the prepolymer BDA850. In some cases, the “Prepolymer” is a segment derived from the prepolymer BDA1300.

In some embodiments, the cyclic carbonate monomer contains four cyclic carbonate groups, such as carbonated GE 61, and the resultant amide-urethane macromolecule is a crosslinked macromolecule. In some embodiments, the crosslinked macromolecule is a star shaped copolymer. With the functionality of the cyclic carbonate monomer equivalent to 4 (f=4) and the functionality of the amidated prepolymer equivalent to 2 (f=2), the stoichiometric ratio of cyclic carbonate monomer to amidated prepolymer is 1:2, and the cyclic carbonate monomer serves as crosslinker in the resultant macromolecule. Based on the degree of crosslinking, the resultant crosslinked macromolecule may be a thermoset, a vitrimer, or an elastomer. In some embodiments, the resultant crosslinked macromolecule is a thermoset. In some embodiments, the resultant crosslinked macromolecule is a vitrimer. In some embodiments, the resultant crosslinked macromolecule is an elastomer.

### Effects of the Prepolymer

Crosslinked polyurethanes derived from the cyclic carbonate monomers and the amine monomers can be prepared and studied to compare the mechanical properties with the amide-urethane macromolecules of the invention. It is found that polyurethanes derived from any one of those amine monomers in Table 2 and CC3 each have an elongation at break below 130%. In contrast, the amidated urethane macromolecules derived from the amidated prepolymers in Table 3 and CC3 surprisingly each have an elongation>400%. The longer chain lengths of the amidated prepolymers than the amine monomers may provide more flexibility for the amine urethane macromolecules and allow entanglements, resulting in a network composed of soft and loose segments connecting to rigid crosslinks, whereas the crosslinked polyurethane from the amine monomers and CC3 do not contain soft segments and cannot form entanglements, in which most segments between rigid crosslinks are taut. Therefore, upon deformation, the soft and loose segments in the amide urethane macromolecules can be stretched and provide impact resistance. The rigid and taut chains in the products from the amine monomers and the cyclic carbonate monomers are subject to break even at a very low strain.

In some embodiments, microphase separation may occur in the amide-urethane macromolecule and also provide improved mechanical properties of the amide-urethane macromolecule. During microphase separation, —NHR_{1D}NH— serves as chain extender, and together with the urethane group on the backbone form a hard segment. When the cyclic carbonate monomers contain three cyclic carbonate groups, about three hard segments join each other via the crosslinker. Meanwhile, multiple hard segments can form powerful hydrogen bonding, which further facilitate the formation of hard segment domains and microphase separation. For the hard segments to be large enough to induce microphase separation, —NHR_{1D}NH— should have at least 4 backbone carbons. For —NHR_{1D}NH— to serve as chain extender in the hard segment, it should be short enough to avoid excessive flexibility. In some cases, the R_{1D} in —NHR_{1D}NH— is a linear or branched hydrocarbon group, R_{1D} should have less than 10 backbone carbons. In some cases, the R_{1D} in —NHR_{1D}NH— may contain one or more backbone cycloalkanes. On the other hand, the amidated prepolymer plays the role of soft segments. n should be at least 2, and R_{1A} and R_{2A} each contain at least four carbons. Preferably, R_{1A} and R_{2A} each contain at least six carbons. Meanwhile, n should be small enough for the urethanization reaction to take place and for the cyclic carbonate monomers to play the crosslinking effect. n should be no more than 10. Those hydrocarbon branches of the carboxylic acid monomers in Table 1 are hydrophobic and flexible, which further facilitate the formation of the soft segment domain. Therefore, with reference to Formula (I), when R_{3A} is —CH(R³¹)CH(R³²)—, R³¹ and R³² each contain at least five carbons. when R_{3A} is substituted C₆-C₁₀ cycloaliphatic hydrocarbon radical or substituted C₆ aromatic hydrocarbon moieties, the ring substituents contain at least five carbons.

As discussed above, it is now possible to manufacture an amide-urethane polymer or macromolecule that is characterized by high elongation at break, as measured with ASTM D638, as published as of the filing date of the application. The macromolecules of the invention, therefore, can have an elongation at break of greater than about 200%, preferably greater than about 250%, more preferably greater than about 300%, preferably between 200%, 250% or 300% and about 700%. In addition, the macromolecules of the invention have excellent tensile strength of at least about 3 MPa, preferably at least about 5 MPa, such as at least about 7 MPa, or at least about 10 MPa, preferably between about 3 MPa, 5 MPa, 7 MPa, or 10 MPa and 25 MPa.

### Effects of the Cyclic Carbonate Monomer

Linseed oil triglyceride can be converted to contain cyclic carbonate groups rather than carbon-carbon double bonds in the fatty acid fragments via epoxidation and carbonation. The carbonated triglyceride can be used to react with the amidated prepolymer in order to compare the effects of cyclic carbonate monomers. The carbonated linseed oil triglyceride is a mixture of different carbonated triglycerides, in which each carbonated triglyceride has a structure analogous to the representative structure Carbonated Linseed TG (I) as shown below:

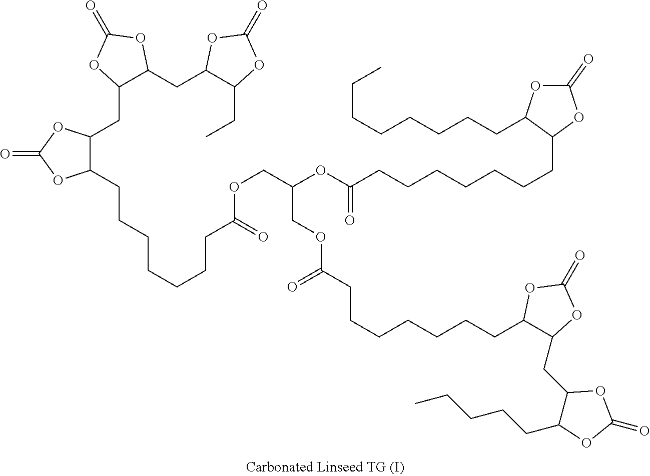 [SMILES: CCCCCCCCC1OC(=O)OC1CCCCCCCC(=O)OC(COC(=O)CCCCCCCC1OC(=O)OC1CC1OC(=O)OC1CCCCC)COC(=O)CCCCCCCC1OC(=O)OC1CC1OC(=O)OC1CC1OC(=O)OC1CC]

It was found the products derived from the carbonated linseed oil triglyceride and the amidated prepolymers show poorer mechanical properties than the amide-urethane macromolecules derived from CC3 and the amidated prepolymer. When prepolymers BDA450, BDA530, BDA850, and BDA1300 react with the carbonated linseed oil triglyceride, the resultant products each have an elongation at break <250%, Young's modulus <24 MPa, and tensile strength <14 MPa according to ASTM D638, as published as of the filing date of this application. In contrast, the amide-urethane macromolecule derived from prepolymer #4 and CC3 has an elongation at break of 700%, Young's modulus of 70 MPa, and tensile strength of 15 MPa. Without being bound by theory, CC3 and other cyclic carbonate monomers as described herein are smaller molecules than carbonated linseed triglyceride and may spread rapidly during reaction with the amidated prepolymers, which gives rise to thorough urethanization reaction and large molecular weight of the resultant amide-urethane macromolecules. Carbonated linseed triglyceride on the other hand are larger molecules and much more viscous and spread much slowly during reaction with the amidated prepolymers, and once reacted, the products can reach to a high viscosity at the early stage of reaction, inhibiting thorough urethanization reaction. The resultant products have a much lower molecular weight than the amide-urethane macromolecules and thus poorer mechanical properties.

### Additives

In some embodiments, the amide-urethane macromolecule may contain one or more polymer additives. A polymer additive is a chemical added to a polymer or a macromolecule to improve processability, prolong the life span, and/or achieve the desired physical or chemical properties in the final product. Polymer additives may include plasticizers, pigments, UV stabilizers, antioxidants, lubricants, surfactants, antifoaming agents, impact modifiers, flame retardants, and nucleating agents.

In some embodiments, the amide-urethane macromolecule may contain one or more surfactants, antifoaming agents, and impact modifier. In some embodiments, the amide-urethane macromolecule may contain one or more surfactants such as sodium dodecyl sulfate (SDS) and/or polydimethylsiloxane (PDMS). In some embodiments, the amide-urethane macromolecule may contain SDS. In some embodiments, the amide-urethane macromolecule may contain SDS and PDMS.

SDS, CH₃(CH₂)₁₁OSO₃Na, contains a hydrophobic hydrocarbon tail and a hydrophilic headgroup and is thus amphiphilic. As described herein, the amidated prepolymer can be amphiphilic and the amphiphilic prepolymer may undergo phase segregation, resulting in a two-phase system that comprises hydrophilic phase and hydrophobic phase. When SDS is added to the amidated prepolymer, it can spread on the interphase between hydrophilic phase and hydrophobic phase to increase the interphase compatibility, thus inhibiting phase segregation on a large scale and facilitating microphase separation of both the amidated prepolymer and the resultant amide-urethane macromolecule.

PDMS is hydrophobic and can induce the microphase separation. Given the flexible nature and large deformability of PDMS, it can dissipate an amount of energy upon external impact and serve as impact modifier. Meanwhile, PDMS also serves as antifoam agent. PDMS has a low viscosity and an affinity to the air-liquid surface. It can spread rapidly on foamy surfaces, causing rupture of the air bubbles and breaking down the surface foam.

Other additives with effects similar to PDMS may be added to the amide-urethane macromolecule, such as liquid butadiene oligomer, liquid polystyrene-butadiene rubber, liquid polyisoprene rubber, liquid polybutadiene rubber, liquid farnesene rubber, mineral oil, and/or petroleum jelly. Examples of liquid oligomers include polyethylene oxide, oligomeric polypropylene oxides, polybutylene oxide, and/or polyhexamethylene oxide.

In some embodiments, a surfactant in the amide-urethane macromolecule can have a concentration between greater than 0 wt % and about 10 wt % relative to the macromolecule.

In some embodiments, a surfactant may have weight average molecular weight between about 100 and about 1,000,000, or between about 10,000 and about 300,000.

In this application, some materials used for the preparation of amide-urethane macromolecule are biobased or bioderived. Whether or not a reactant or product described herein is “bioderived” or “bio-based” may be determined by analytical methods. Using radiocarbon and isotope ratio mass spectrometry analysis, the bio-based content of materials can be determined. ASTM International, formally known as the American Society for Testing and Materials, has established a standard method for assessing the biobased content of carbon-containing materials as published as of the earlier of the filing date of the application or the earliest claimed priority date. The ASTM method is designated ASTM-D6866. The application of ASTM-D6866 to derive a “biobased content” is built on the same concepts as radiocarbon dating, but without use of the age equations. The analysis is performed by deriving a ratio of the amount of radiocarbon (14C) in an unknown sample to that of a modern reference standard. The ratio is reported as a percentage with the units “pMC” (percent modern carbon). If the material being analyzed is a mixture of present-day radiocarbon and fossil carbon (containing no radiocarbon), then the pMC value obtained correlates directly to the amount of biomass material present in the sample. Thus, ASTM-D6866 may be used to validate that the compositions described herein are and/or are not derived from renewable sources.

As used in this specification and the appended claims, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure and so forth.

The term “comprising”, which is used interchangeably with “including”, “containing”, or “characterized by”, is inclusive or open-ended language and does not exclude additional, unrecited elements or method steps.

The phrase “consisting of” excludes any element, step, or ingredient not specified in the claim. The phrase “consisting essentially of” limits the scope of a claim to the specified materials or steps and those that do not materially affect the basic and novel characteristics of the claimed invention. The present disclosure contemplates embodiments of the invention compositions and methods corresponding to the scope of each of these phrases. Thus, a composition or method comprising recited elements or steps contemplates particular embodiments in which the composition or method consists essentially of or consists of those elements or steps.

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

### EXAMPLES

### Preparation of Carbonate-Containing Reactants

### Method of Making Carbonated Linseed Triglyceride:

A polymer/resin was successfully synthesized using carbonated linseed triglyceride as comparator. The double bonds in linseed oil were first epoxidized. The resultant epoxy groups were subsequently converted to cyclic carbonate groups by reaction with CO₂, resulting in the production of carbonated linseed triglyceride. In a typical reaction, an epoxidized linseed oil (EPOXOL® 9-5, ACS Technical Products) and TBAB were placed in a parr reactor at 140° C. with a CO₂ pressure of 500 psi. The level of conversion was monitored via ¹H NMR spectroscopy by the disappearance of the proton signals associated with the epoxy group. Upon completion, the resin was dissolved in ethyl acetate and washed three times with distilled water to remove the TBAB catalyst. The organic layer was then rotary evaporated to remove remaining solvent. The dried carbonated linseed triglycerides were collected and stored for future use.

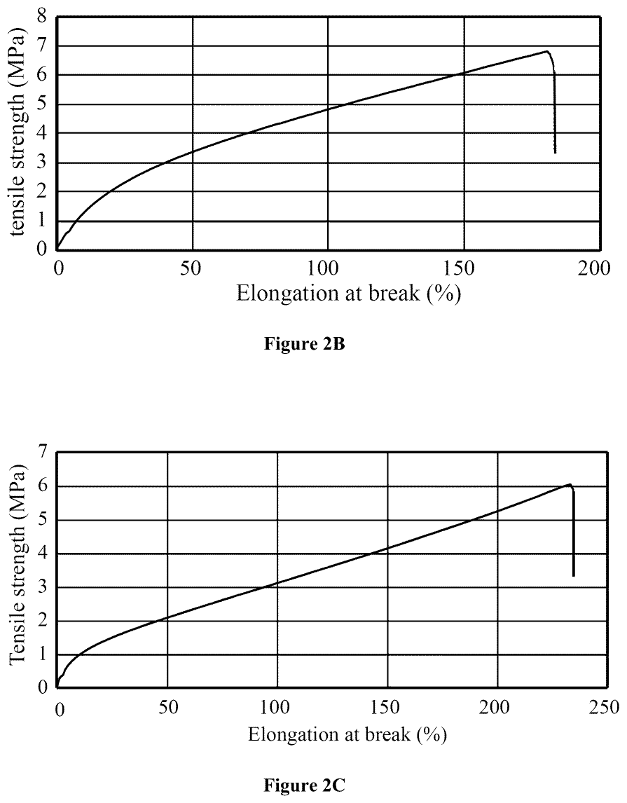

The carbonated linseed triglyceride reacted with the amidated prepolymers BDA 350, BDA 850, and BDA 1300 and resulted in three non-isocyanate polyurethanes (NIPU), respectively. The resultant NIPUs demonstrated a characteristic plastic performance, as shown in the tensile curves illustrated in FIG. 2A-2C.

Method of Making Cyclic Carbonate Monomers from Linseed Oil:

Epoxidized linseed oil fatty acid methyl ester (epoxidized linseed FAME) was synthesized through transesterification of an epoxidized linseed oil (EPOXOL® 9-5, ACS Technical Products). The transesterification reaction was conducted in a 500 mL round-bottom flask. Epoxidized linseed oil (200 g) and a certain amount of co-solvent (acetone, 5 wt. %) were added to the flask. A solution of the established NaOH catalyst (1.1 wt. %) concentration in methanol was prepared and added to the flask. Then the mixture was magnetically stirred at room temperature (25° C.) for 10 minutes. After the reaction completion, the product was washed with deionizer water to remove the remaining NaOH catalyst. And the remaining water was dried by anhydrous sodium sulfate. Finally, the organic layer was rotary evaporated to remove remaining solvent. As illustrated in Scheme (I), the resultant carbonated linseed FAME was a mixture of CC1, CC2, and CC3.

Carbonated linseed FAME was then used to prepare the cyclic carbonate monomer CC3. Hexane and toluene (1:4, volume ratio) were added into carbonated linseed FAME (solvent: carbonated linseed FAME=5:1, weight ratio). The bottom layer was collected and the solvent in it was removed by rotovap. The solvent-free liquid from the bottom layer was then dissolved in the hexane/toluene mixture at same weight/volume ratio. CC3 was obtained by repeating this procedure for three times. The purity of CC3 in the enriched fraction was about 85% which was calculated by ¹H NMR. Ideally, the functionality of CC3 is 3, which means there are 3 cyclic carbonate groups in one CC3 molecule. Finally, the functionality of prepared CC3 sample was 2.85 indicating the 85% of purity. The yield was 35%.

Method of Making Cyclic Carbonate Monomers from Other Starting Materials:

Other biobased cyclic carbonate monomers were prepared by catalytic reaction of CO₂ with biobased epoxies in the presence of tetrabutylammonium bromide (TBAB) (5 mol % with respect to epoxy groups). In the typical synthesis, the epoxies (ERISYS RDGE, ERISYS GS120, ERISYS GE21, ERISYS GE25, ERISYS GE31, ERISYS GE35, and ERISYS GE61, CVC Thermoset Specialties) and TBAB were placed in a parr reactor at 140° C. with a CO₂ pressure of 500 psi. The level of conversion was monitored via ¹H NMR spectroscopy by the disappearance of the proton signals associated with the epoxy group.

Upon completion, the resin was dissolved in ethyl acetate and washed three times with distilled water to remove the TBAB catalyst. The organic layer was then rotary evaporated to remove remaining solvent. The dried carbonated materials (carbonated RDGE, carbonated GS120, carbonated GE21, carbonated GE25, carbonated GE31, carbonated GE35, and carbonated GE61) were collected and stored for future use.

The chemical structures of carbonated RDGE, carbonated GS120, carbonated GE21, carbonated GE25, carbonated GE31, carbonated GE35, and carbonated GE61 were provided above. Carbonated GS120, as a comparator used in this application, has the formula as shown below:

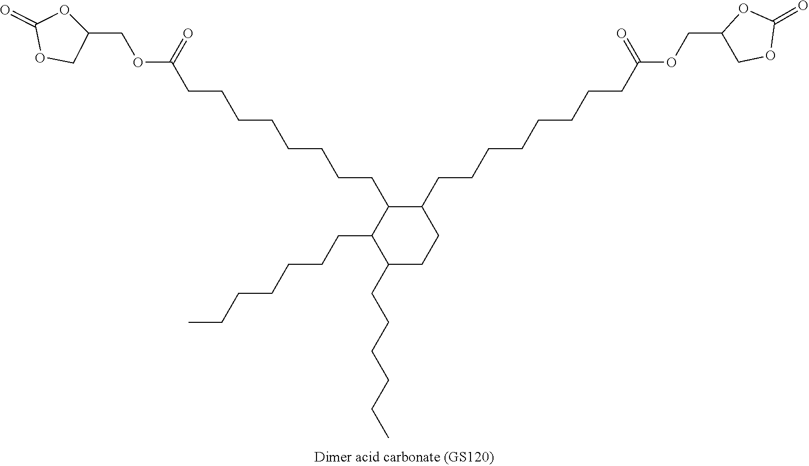 [SMILES: CCCCCCCC1C(CCCCCC)CCC(CCCCCCCCC(=O)OCC2COC(=O)O2)C1CCCCCCCCC(=O)OCC1COC(=O)O1]

### Evaluation of Biobased Carbonate-Containing Reactants

According to ASTM-D6866, the renewable content and CO₂ content of each biobased carbonate-containing reactant were calculated as shown in Table 4. f refers to the functionality of the reactant, i.e., the number of cyclic carbonates per reactant molecule. Renewable content was calculated by (number of renewable carbons)/(number of total carbons). CO₂ content was calculated by (weight of CO₂ reacted by epoxy)/(weight of cyclic carbonate).

TABLE 4

| | Carbonate- | | | |
|---|---|---|---|---|
| | containing | | Renewable | CO₂ |
| Source | reactants | ƒ | content | content |
| Linseed oil | Carbonated linseed | 6.3 | 100% | 23.5% |
| | triglyceride | | | |
| | Carbonated linseed | 2.1 | 100% | 23.4% |
| | FAME | | | |
| | CC3 | 2.87 | 100% | 28.0% |
| Castor oil | Carbonated GE35 | 2.5 | 89% | 10.7% |
| Resorcinol | Carbonated RDGE | 2 | 53% | 28.3% |
| Hexanediol | Carbonated GE25 | 2 | 53% | 27.6% |
| Trimethylolethane | Carbonated GE31 | 3 | 18% | 31.4% |
| Sorbitol | Carbonated GE61 | 4 | 100% | 30.2% |

### Method of Making CC3 Diesters

C3 (0.04 mol), diol (0.016 mol), and a certain amount of solvent (toluene, 50 ml) were added to the flask. The lipase from Candida antarctica B (Lipozyme CALB) was then added to the flask. Then the mixture was magnetically stirred at about 60° C. for about 5 days. The volatile components were removed daily by vacuum to reduce accumulation of methanol byproduct, and toluene solvent was added afterward to reduce viscosity for better mixing. After the reaction completion, the product was washed with methanol to remove unreacted CC3. The remaining layer was then rotary evaporated to remove the remaining solvent. An exemplary chemical structure of CC3 diester was illustrated above.

### Preparation of Amine Reactants

### Method of Making Amidated Prepolymers:

A variety of amidated prepolymers were produced by reacting a diamine (ethane diamine (EDA), butane diamine (BDA), hexanediamine (HAD), norspermidine (NSD), or m-xylene diamine (MXDA)) with a dimer acid (Pripol™ 1027 or 1009) respectively via condensation reaction.

For example, the dimer acid Pripol™ 1009 (CRODA) and 1,4-diaminobutane (BDA, Sigma-Aldrich) were reacted with to produce the amidated prepolymer. BDA was added to a round bottom flask with a magnetic stir and preheated to 120° C. Then the dimer acid was added dropwise at 120° C. The reaction flask was equipped with a condenser and N₂ purge. Then, the reaction was carried out at 180° C. for 12 h. To achieve amidated prepolymer with —NH₂ at each chain end, BDA was added at an overstoichiometric amount, i.e., the molar ratio of BDA/dimer acid is above 1. To vary the chain lengths of amidated prepolymers, different molar ratios of BDA to dimer acid were chosen. When the molar ratios of BDA/dimer acid were 4, 2 and 1.6, the amidated prepolymers BDA350, BDA850 and BDA1300 were produced, respectively. After the reaction completion, the excess BDA and water was removed by vacuum distillation and/or by use of a nitrogen sweep. The primary amine equivalent weight (PAEW) of the resultant amidated prepolymer was titrated using HCl solution and calculated, per ASTM D2074. The amidated prepolymers were then named by its PAEW number. For example, if the PAEW=530, then it is BDA530.

### Method of Making Other Amine Reactants:

Other amine reactants were also prepared to further react with CC3 monomers. For example, citric acid triethyl ester (i.e., triethyl citrate, Sigma-Aldrich) and excess amount of 1,6-hexanediamine (HDA, Sigma-Aldrich) were reacted at a molar ratio of triethyl citrate/HDA=about 1:7.5. The reaction was carried out at about 110° C. for about 6 hours. The resulting ethanol was removed by rotary evaporator at about 50° C. under vacuum. A yellow liquid mixture of HDA amide triamine was obtained.

As another example, the reaction of triethyl citrate and EDR 148 (Huntsman) with a molar ratio of triethyl citrate/EDR 148=about 1:3 was carried out at about 110° C. for about 6 hours. The resulting ethanol was removed by distillation using a rotary evaporator at about 50° C. under vacuum. A yellow liquid of EDR 148 amide triamine was obtained.

### Evaluation of Biobased Carbonate-Containing Reactants:

According to ASTM-D6866, the renewable content and CO₂ content of each biobased amine reactant were calculated as shown in Table 4. f refers to the functionality of the reactant, i.e., the number of primary amine per molecule. Renewable content was calculated by (number of renewable carbons)/(number of total carbons). Equivalent weight represents the primary amine equivalent weight (PAEW) titrated using HCl solution according to ASTM D2074. These are tabulated for different amine reactants in Table 5 below.

TABLE 5

| | | Equivalent | Renewable |
|---|---|---|---|
| Amine reactant | ƒ | weight | content |
| HDA citric amide triamines | 2.67 | 136 | 100% |
| EDR 148 amide triamine | 3 | 194 | 100% |
| BDA1300 | 2 | 1300 | 100% |
| BDA850 | 2 | 850 | 100% |
| BDA350 | 2 | 350 | 100% |
| EDA400 | 2 | 400 | 100% |
| HDA450 | 2 | 450 | 100% |
| MXDA350 | 2 | 350 | 69% |
| NSD350 | 2 | 450 | 100% |

### Preparation of Amide-Urethane Macromolecules

A series of polymers/resins were synthesized by the aminolysis reaction of carbonate-containing reactants with amine reactants. The reaction of the cyclic carbonate functional groups with the amine functional groups is described above. According to the stoichiometric ratio between the reactants, cyclic carbonates and amines were placed into a speedmixer jar (FlackTek, US), then the mixture was mixed at about 3000 rpm for about 2 minutes. After that, the mixture was stirred at a temperature maintained between about 70° C. and about 110° C. for a period of time between about 1 minute and about 30 minutes before it was poured into a polytetrafluoroethylene (PTFE) mold to prepare ASTM D638 type IV dog bone samples. Thereafter, the liquid mixture in the mold was cured at a temperature between about 70° C. and about 110° C. for about 12 hours and at about 110° C. for an additional 12 hours in a vacuum oven.

Preparation of Amide-Urethane Macromolecules from Prepolymers and CC3:

Each of prepolymers BDA450, BDA530, and BDA850 and CC3 were placed into the speedmixer jar and mixed at 100° C. under vacuum for 2 minutes. After that, the solvent-free mixture was poured into PTFE mold to prepare ASTM D638 type IV dog bone samples. Thereafter, the liquid mixture was cured at 110° C. for 24 hours in a vacuum oven.

In comparison with carbonated triglyceride, CC3 has a much lower viscosity and thus allows shorter reaction time and lower reaction temperatures when reacting with the same prepolymer for preparation of the macromolecules.

Preparation of Amide-Urethane Macromolecules with Additives:

Amide-urethane macromolecules derived from BDA530 and CC3 were prepared with PDMS and/or SDS added in the formulations. Two PDMSs with number-average molecular weights of 17,000 and of 92,000 were added to the formulations respectively with a content of 3% over the total formulation by weight, with the presence or absence of SDS. SDS was added to the formulations with a content of 1%, 2%, or 3% over the total formulation by weight, with the presence or absence of PDMS. During preparation, PDMS and/or SDS were added to the prepolymer BDA530 and mixed at about 100° C. for a period between about 1 hour and about 10 hours. Then CC3 was added to the mixture to start the reaction.

### Test of Reprocessability

Amine-urethane macromolecules derived from prepolymers (BDA450, BDA530, and BDA850) and CC3, from prepolymers (BDA450, BDA530, and BDA850) and carbonated GE31 were tested for reprocessability. Material reprocessing was conducted using a Carver hydraulic laboratory press. The original macromolecule was cut into small pieces and pressed into sheets at 150° C. with a pressure of 2000 psi. The reprocessing time to form a uniform film from shredded sample was 10 min. The reprocessed film from original materials was considered as the 1st time reprocessed NIPU. Similarly, the same reprocessing procedure was performed to obtain the 2nd and 3rd time reprocessed NIPU.

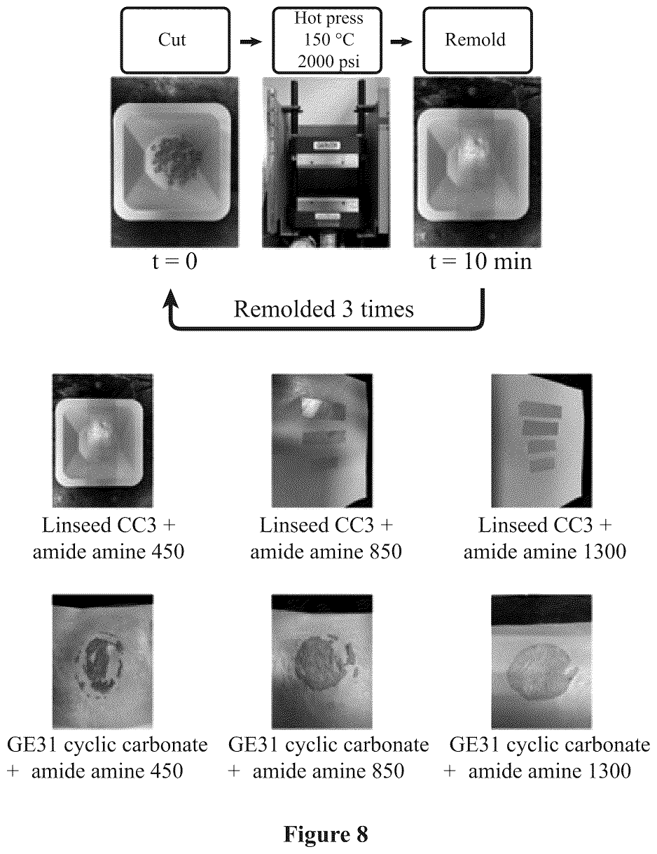

Photographs recording the reprocessing were present in FIG. 8. Macromolecules derived from prepolymers and CC3 possess the reprocessability of a vitrimer, as the bond exchange can occur between the adjacent urethane groups. However, the GE31 derived NIPUs do not have reprocessability, as the urethane groups are relatively far from each other for covalent bonding exchanging.

### Mechanical Test

### Tensile Test:

Standard tensile tests were conducted to the NIPUs according to ASTM D638.

The mechanical properties of NIPUs were presented in Tables 6-11 as shown below.

TABLE 6
NIPUs derived from CC3 and prepolymers.

| Cyclic | | | Young's | Tensile | Elongation |
|---|---|---|---|---|---|
| carbonate | | Con- | modulus | strength | at break |
| monomer | Prepolymer | version | (MPa) | (MPa) | (%) |
| CC3 | BDA1300 | 89% | 70 | 15 | 702 |
| | BDA850 | 83% | 40 | 12.6 | 552 |
| | BDA530 | 85% | 71 | 8.2 | 507 |
| | BDA450 | — | 23 | 8.0 | 408 |
| | BDA350 | — | 8.6 | 19.5 | 399 |
| | EDA 400 | — | 26 | 5.2 | 66 |
| | HDA 450 | — | 1 | 2.8 | 492 |
| | MXDA 350 | — | 92 | 4 | 333 |
| | NSD 450 | — | 2 | 0.3 | 1100 |

Conversions of reactions between CC3 and BDA1300, BDA850, and BDA530, respectively, were monitored by using FTIR.

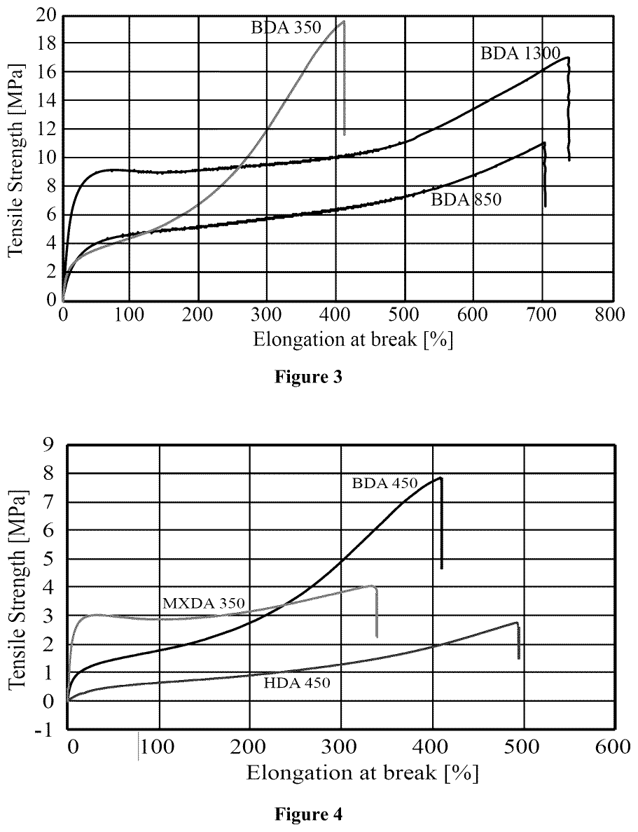

The tensile curves of NIPUs synthesized from CC3 with three different amidated prepolymers, BDA 1300, BDA 850, and BDA 350, respectively, were provided in FIG. 3. The tensile curves of NIPUs synthesized from CC3 and three different amidated prepolymers, BDA 450, HDA 450, and MXDA 350, respectively, were provided in FIG. 4.

TABLE 7
NIPUs derived from CC3 and BDA530 with additives.

| Cyclic | | | | | Young's | Tensile | Elongation |
|---|---|---|---|---|---|---|---|
| carbonate | | SDS | PDMS | PDMS | modulus | strength | at break |
| monomer | Prepolymer | (wt %) | (wt %) | Mw | (MPa) | (MPa) | (%) |
| CC3 | BDA530 | 0 | 0 | — | 71 | 8.2 | 507 |
| | | 3 | 0 | — | 102 | 15.6 | 610 |
| | | 0 | 3 | 17k | 4 | 2.4 | 591 |
| | | 1 | 3 | 17k | 144 | 14.8 | 567 |
| | | 2 | 3 | 17k | 120 | 12.6 | 539 |
| | | 3 | 3 | 17k | 98 | 8.7 | 575 |
| | | 0 | 3 | 92k | 67 | 7.8 | 602 |
| | | 1 | 3 | 92k | 100 | 10.1 | 561 |
| | | 2 | 3 | 92k | 120 | 18.2 | 601 |
| | | 3 | 3 | 92k | 122 | 17.3 | 629 |

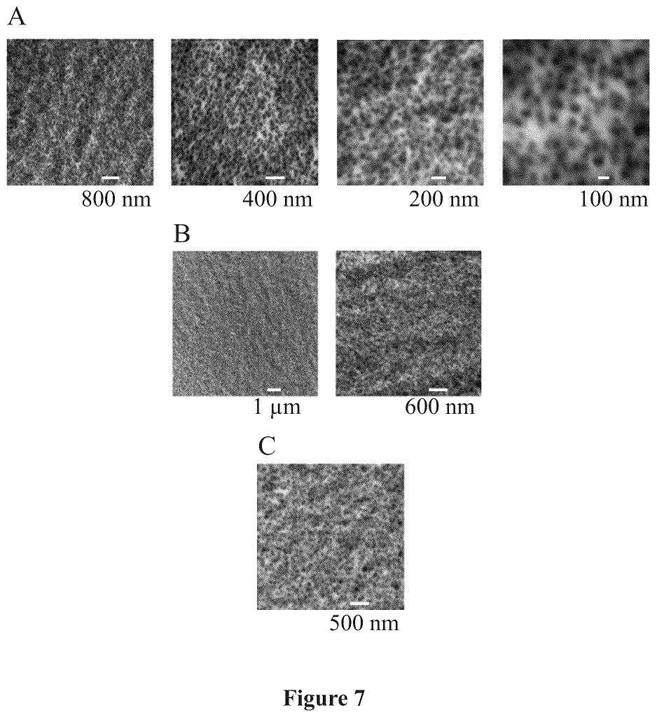

The tensile curves of NIPUs derived from CC3 and BDA530 were compared for the effect of the additives in FIG. 7. With the addition of 2 wt % SDS and 3 wt % PDMS (M_{w}92,000), the resultant macromolecule exhibited more than doubled tensile strength and about 30% improvement in elongation at break than the one without the additives.

TABLE 8
NIPUs derived from CC3/carbonated FAME and diamines.

| Cyclic | | | Young's | Tensile | Elongation |
|---|---|---|---|---|---|
| carbonate | | Con- | modulus | strength | at break |
| monomer | Diamine | version | (MPa) | (MPa) | (%) |
| Carbonated | BDA | 78% | 912 | 1.5 | 0.2 |
| FAME | | | | | |
| CC3 | BDA | 89% | 1440 | 29.9 | 2.6 |
| | NSD | 90% | 1886 | 14.4 | 0.9 |
| | EDR 148 | 81% | 1.0 | 0.8 | 129.6 |
| | 1074 | 87% | 1.1 | 0.2 | 100.1 |
| | MXDA | 87% | 2005 | 14.6 | 1.03 |

As a comparator, 1074 in Table 8 is a fatty acid diamine with the chemical structure as shown below:

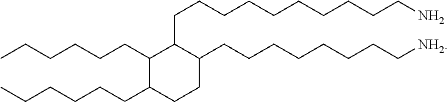 [SMILES: CCCCCCC1CCC(CCCCCCCCN)C(CCCCCCCCCCN)C1CCCCCC]

In Table 8, NIPU derived from CC3 and BDA exhibited higher Young's modulus, higher tensile strength, and higher elongation at break than NIPU derived from its unpurified precursor, carbonated FAME, and BDA. After purification, the functionality was improved from 2.1 for carbonated FAME to 2.87 for CC3, which, after reacting with BDA, corresponded to higher degree of crosslinking and higher molecular weight in the resultant NIPU and thus improved mechanical performance.

Comparing Tables 5 and 8, NIPUs derived from CC3 and diamines were more rigid and less flexible than NIPUs derived from CC3 and prepolymers. The prepolymers are superior monomers than their corresponding diamines as they have longer chain lengths that can be converted to longer and more mobile segments between crosslinks after reacting with CC3 and provided high flexibility; and they contain amide groups (from the amidation reaction) and fatty chain groups (from the carboxylic acid monomers, such as Pripol™ 1009) and the difference between the polarities of amides and fatty chains can induce microphase or nanophase separation wherein the relatively polar phase (hard phase) provide rigidity and the relatively nonpolar phase (soft phase) provide flexibility and thus further enhance the mechanical performance.

TABLE 9
NIPUs derived from carbonated linseed triglyceride
and prepolymers/diamines

| Cyclic | | | Young's | Tensile | Elongation |
|---|---|---|---|---|---|
| carbonate | Prepolymer/ | Con- | modulus | strength | at break |
| monomer | Diamine | version | (MPa) | (MPa) | (%) |
| carbonated | BDA1300 | 88% | 23 | 13.1 | 240 |
| linseed | BDA850 | 71% | 12 | 6.8 | 181 |
| triglyceride | BDA350 | 72% | 8 | 6.8 | 233 |
| | BDA350 in | 82% | 11 | 16.8 | 240 |
| | chloroform | | | | |
| | BDA | 81% | 1217 | 35.5 | 4.1 |
| | HDA | 86% | 1093 | 39.3 | 6.5 |
| | NSD | 88% | 1761 | 25.4 | 2.1 |
| | EDR 148 | 81% | 192 | 11.3 | 85.5 |
| | 1074 | 91% | 2 | 1.1 | 89.6 |
| | MXDA | 90% | 1117 | 29.5 | 3.0 |

FIG. 2A to 2C provide the tensile curves of NIPUs derived from carbonated linseed triglyceride reacted with BDA350, BDA850, and BDA1300, respectively.

When reacted with the same prepolymer, CC3 exhibited superior mechanical properties than its starting material carbonated linseed triglyceride: e.g., when reacted with BDA1300, CC3 resulted in a macromolecule with Young's modulus of 70 MPa and elongation at break of 702%, whereas carbonated linseed triglyceride led to a macromolecule with Young's modulus of 23 MPa and elongation at break of 240%.

TABLE 10
NIPUS derived from other cyclic carbonate monomers and
prepolymers/diamines/amide triamines

| Cyclic | Prepolymer/ | | Young's | Tensile | Elongation |
|---|---|---|---|---|---|
| Carbonate | Diamine/ | Con- | modulus | strength | at break |
| monomer | Triamine | version | (MPa) | (MPa) | (%) |
| Carbonated | BDA1300 | 81% | 147 | 14.8 | 434 |
| GE31 | BDA850 | 80% | 131 | 12.1 | 339 |
| | BDA450 | 80% | 99 | 10.5 | 246 |
| | EDA400 | 88% | 3 | 1.7 | 123 |
| | HDA450 | 75% | 4 | 7.6 | 399 |
| Carbonated | BDA850 | 84% | 5.1 | 5.6 | 50 |
| GE25 | NSD | 86% | 0.5 | 0.1 | 412.3 |
| | MXDA | 87% | 74 | 2.2 | 303.1 |
| | HDA amide | 84% | 8.3 | 8.6 | 205.7 |
| | triamine | | | | |
| Carbonated | BDA850 | 86% | 122 | 14.5 | 400 |
| GE61 | NSD450 | 87% | 123 | 9.4 | 91 |
| Carbonated | BDA530 | 92% | / | 10.6 | 502 |
| RDGE | EDR 148 | Not | 3500 | 18.9 | 3.4 |
| | | measured. | | | |
| | 1074 | Not | 0.5 | 0.4 | 240.4 |
| | | measured. | | | |
| Carbonated | BDA | 93% | 0.6 | 0.38 | 112.6 |
| GS120 | NSD | 92% | 0.1 | 0.1 | 230.3 |
| | EDR 148 | 94% | 0.2 | 0.1 | 200 |
| | 1074 | 93% | 0.1 | 0.1 | 400 |
| | MXDA | 92% | 1.4 | 1.0 | 214.0 |
| | HDA amide | 92% | 3.4 | 2.6 | 115.2 |
| | triamine | | | | |

Additional NIPUs were prepared and not tested as they were unable to bear tensile stretch, including: NIPUs derived from GE25 and 1074, GE25 and EDR 148, or GE35 and each diamine (BDA, HDA, NSD, EDR 148, 1074, or MXDA) were too soft to be testable. NIPUs derived from carbonated RDGE and NSD, or carbonated RDGE and MXDA were too brittle to be testable.

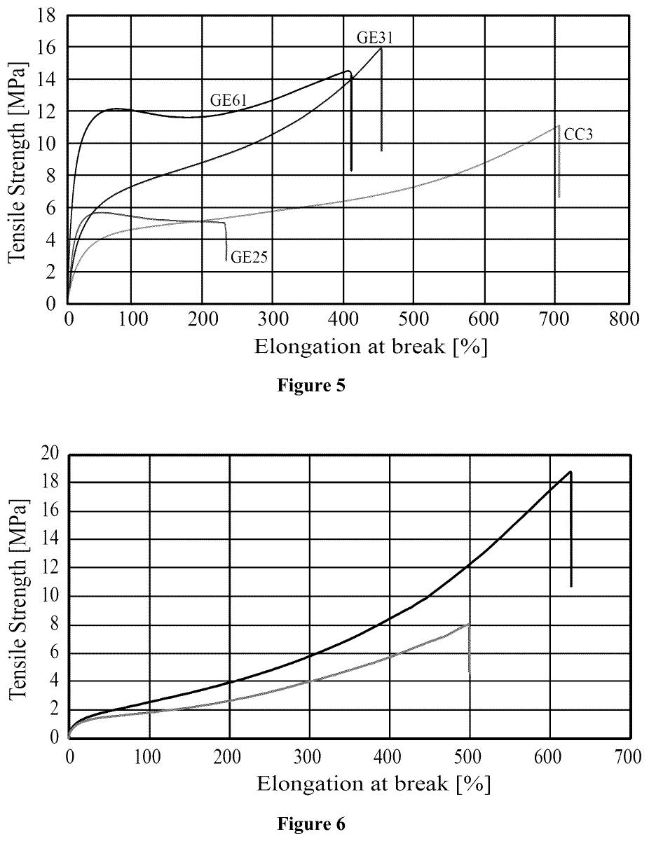

The tensile curves of NIPUs synthesized from BDA850 and different cyclic carbonate monomers, CC3, GE25, GE31, and GE61, respectively, were compared in FIG. 5.

TABLE 11
NIPUs derived from one or more cyclic carbonate monomers
and one or more prepolymers

| | | Young's | Tensile | Elongation |
|---|---|---|---|---|
| Cyclic carbonate | Pre- | modulus | strength | at break |
| monomer | polymer | (MPa) | (MPa) | (%) |
| Carbonated RDGE | BDA530 | — | 10.6 | 502 |
| (24 wt %) | (76 wt %) | | | |
| Carbonated RDGE (20 wt %) | BDA530 | 161 | 10.7 | 439 |
| B-tough ™ C2x (10 wt %) | (70 wt %) | | | |
| Carbonated RDGE (17 wt %) | BDA530 | 47.5 | 6.5 | 472 |
| PEG500 (10 wt %) | (73 wt %) | | | |
| Carbonated RDGE (14 wt %) | BDA530 | 43 | 7.3 | 467 |
| Carbonated GE21 (10 wt %) | (76 wt %) | | | |
| Carbonate RDGE (31 wt %) | BDA530 | 362 | 14.3 | 504 |
| | (64 wt %), | | | |
| | EDR 148 | | | |
| | (5 wt %) | | | |

In the cases that B-tough™ C2x and PEG 500 were used, they were premixed with RDGE respectively before reacting with prepolymers.

In some embodiments, the material of this invention further comprises a surfactant. The effects of Surfactant on the mechanical properties were evaluated. Surfactants can lower the surface tension or interfacial tension between cyclic carbonate and amine compounds, which can affect the microphase or nanophase separation and thus the properties of produced NIPU. A series of surfactants from fatty acid and commonly used base were synthesized and added to the material system to assess the effects of surfactants on the mechanical performance of resultant NIPUs.

Synthesis of fatty acid 1009 ammonium. Fatty acid Pripol™ 1009 (obtained from Croda, as shown in Table 1) was used a starting material. The fatty acid 1009 ammonium was synthesized by mixing Pripol™ 1009 and excess amount of ammonia solution. After reaction, the excess ammonia and water were evaporated by rotovap. The final product is clear viscous liquid.

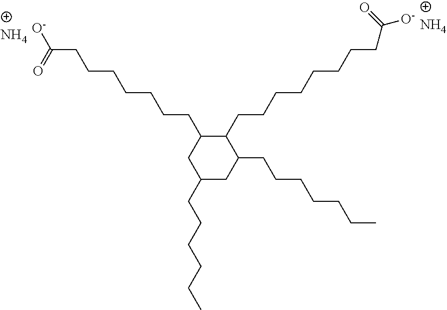 [SMILES: [NH4+] ; CCCCCCCC1CC(CCCCCC)CC(CCCCCCCC(=O)[O-])C1CCCCCCCCC(=O)[O-] ; [NH4+]]

Effect of fatty acid 1009 ammonium on NIPU tensile properties. For linseed CC3-BDA450 formula, the Young's Modulus and tensile strength increased with increasing amount of 1009 ammonium surfactant. Another set of the formulas were based on GE31 and BDA450. The tensile results showed adding 1009 ammonium slightly increased the tensile strength. Similar results were also observed by using RDGE as a carbonate monomer. Small amount of surfactant increased the modulus and tensile performance. However, as shown in Table 12, the addition of surfactant at 1.5 wt %, 2 wt %, or 5 wt % reduced the modulus as the excess amount of surfactants served as plasticizers in the polymer.

TABLE 12
NIPUs derived from cyclic carbonate monomers
and BDA450 with the presence of surfactant

| | | Young's | Tensile | Elongation |
|---|---|---|---|---|
| Cyclic | | Modulus | Strength | at break |
| Carbonate | Diamine | (MPa) | (MPa) | (%) |
| CC3 | BDA450 | 92 | 7.8 | 407 |
| CC3 | BDA450 + 1 wt % | 193 | 10.8 | 326 |
| | 1009 ammonium | | | |
| CC3 | BDA450 + 5 wt % | 184 | 12 | 376 |
| | 1009 ammonium | | | |
| Carbonated | BDA450 | 194 | 10.1 | 250 |
| GE31 | | | | |
| Carbonated | BDA450 + 0.5 | 214 | 11.6 | 282 |
| GE31 | wt % 1009 | | | |
| | ammonium | | | |
| Carbonated | BDA450 + 1 wt % | 279 | 11.9 | 257 |
| GE31 | 1009 ammonium | | | |
| Carbonated | BDA450 + 1.5 | 187 | 12.6 | 293 |
| GE31 | wt % 1009 | | | |
| | ammonium | | | |
| Carbonated | BDA450 + 5 wt % | 165 | 10 | 316 |
| GE31 | 1009 ammonium | | | |
| Carbonated | BDA450 | 244 | 14.8 | 308 |
| RDGE | | | | |
| Carbonated | BDA450 + 1 wt % | 361 | 18.6 | 310 |
| RDGE | SDS | | | |
| Carbonated | BDA450 + 2 wt % | 196 | 10.5 | 263 |
| RDGE | SDS | | | |

### Solvent Solubility Test

NIPUs derived from carbonated RDGE and prepolymers were tested for their solubilities in organic solvent.

Unlike thermoplastic polyurethanes (TPU), NIPUs as presented in Table 11 can be dissolved in tetrahydrofuran (THF) and thus can be used as a replacement for TPU when solvent solubility is required.

### Morphology Characterization

Transmission electron microscopy (TEM) was conducted to NIPUs. FIG. 7 presents the TEM images of NIPUs synthesized from CC3 and BDA530 (A), CC3 and BDA530 with 3 wt % SDS (B), and CC3 and BDA530 with 2 wt % SDS and 3 wt % PDMS with M_{w} of 92,000 (C). A two-phase morphology was observed in the three NIPUs tested which could be originated by crosslinking and micro/nanophase separation. The dark regions were corresponding to the relatively polar phase (hard phase) with higher electron density and the bright regions were corresponding to the relatively nonpolar phase (soft phase) with lower electron density.

In NIPU derived from CC3 and BDA530, —NH(CH₂)₄NH— at each end of the prepolymer segment jointed with CC3 (serves as crosslinker) via the urethane group together can aggregate and form one hard segment domain. —NH(CH₂)₄NH— groups, whether at the ends or inside of the prepolymer segments, themselves can form another hard segment domain. The hard phase, i.e., the dark regions on TEM images, can comprise either or both of the two hard segment domains. The soft phase, i.e., the bright regions on TEM images, comprises the fatty segment from the carboxylic acid monomer as shown below:

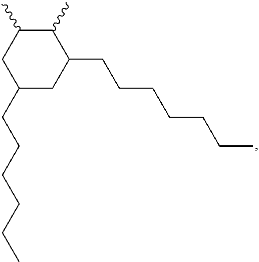

wherein the [symbol] represents —(CH₂)ₚ—, and p is 1, 2, 3, 4, 5, or 6.

1. A macromolecule having a tensile strength of at least about 3 MPa and elongation at break of at least about 200% according to ASTM D638, wherein the macromolecule comprises a plurality of amidated prepolymer chains, each amidated prepolymer chain comprising an amine (—NH₂) group at each chain end, derived from a carboxylic acid monomer and an amine monomer wherein the amine monomer is in an overstoichiometric amount; and wherein each amidated prepolymer chain is linked to one or more amidated prepolymer chains via a cyclic carbonate monomer wherein each cyclic carbonate monomer is a fatty acid ester and contains one or more cyclic carbonate groups.

2. The macromolecule of claim 1, wherein the carboxylic acid monomer is a dimer acid of a fatty acid comprising 12-22 carbons.

3-4. (canceled)

5. The macromolecule of claim 1, wherein the carboxylic acid monomer is a trimer acid of a fatty acid comprising 14-18 carbons.

6. The macromolecule of claim 1, wherein the carboxylic acid monomer is an aliphatic dicarboxylic acid comprising 6-24 carbons.

7. The macromolecule of claim 1, wherein the carboxylic acid monomer is represented by Formula (I): 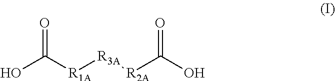
Wherein R_{1A} and R_{2A} are each independently selected from the group consisting of substituted or unsubstituted C₃-C₁₇ alkane moieties, substituted or unsubstituted C₃-C₁₇ alkene moieties, and substituted or unsubstituted C₃-C₁₇ alkyne moieties; and
R_{3A} is absent or —CH(R³¹)CH(R³²)—, wherein R³¹ and R³² are each independently selected from a substituted or unsubstituted C₄-C₁₂ alkyl, a substituted or unsubstituted C₄-C₁₂ alkenyl, and a substituted or unsubstituted C₄-C₁₂ alkynyl, or R³¹ and R³² together with the carbons they are attached to form a substituted C₆-C₁₀ cycloaliphatic hydrocarbon group or a substituted C₆ aromatic hydrocarbon group, and the C₆-C₁₀ cycloaliphatic hydrocarbon groups and/or the C₆ aromatic hydrocarbon groups can also be optionally fused, wherein the substituents on the cycloaliphatic hydrocarbon group and/or on the aromatic hydrocarbon group are independently selected from a substituted or unsubstituted C₄-C₁₂ alkyl, a substituted or unsubstituted C₄-C₁₂ alkenyl, and a substituted or unsubstituted C₄-C₁₂ alkynyl.

8-11. (canceled)

12. The macromolecule of claim 1, wherein the amine monomer comprises 4-20 carbons and 2 or 3 —NH₂.

13. The macromolecule of claim 12, wherein the amine monomer is a diamine (i.e., comprises 2 —NH₂).

14-15. (canceled)

16. The macromolecule of claim 1, wherein the molar ratio of amine monomer to carboxylic acid monomer is about 11:10 to about 20:1.

17-18. (canceled)

19. The macromolecule of claim 7, wherein the amidated prepolymer is represented by: 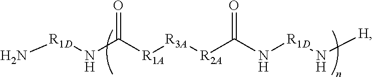
Wherein n is about 1 to about 10; and
R_{1D} is selected from substituted or unsubstituted C₂-C₂₀ alkane moiety, substituted or unsubstituted C₂-C₂₀ alkene moiety, substituted or unsubstituted C₆-C₁₀ cycloaliphatic hydrocarbon moiety, or substituted or unsubstituted C₆ aromatic hydrocarbon moiety; the cycloaliphatic hydrocarbon radical and/or aromatic hydrocarbon moiety can be optionally fused.

20. The macromolecule of claim 19, wherein n is about 1 to about 6.

21. The macromolecule of claim 19, wherein R_{1D} is an unsubstituted C₄-C₈ alkane radical.

22. The macromolecule of claim 1, wherein the cyclic carbonate monomer is a fatty acid ester derived from vegetable oil.

23. The macromolecule of claim 22, wherein the cyclic carbonate monomer is a fatty acid ester derived from linseed oil.

24. The macromolecule of claim 23, wherein the cyclic carbonate monomer comprises three cyclic carbonate groups.

25. The macromolecule of claim 24, wherein the cyclic carbonate monomer is CC3.

26. The macromolecule of claim 22, wherein the cyclic carbonate monomer is a fatty acid ester derived from Brazil nut oil, corn oil, cottonseed oil, grape seed oil, hemp seed oil, rice bran oil, sesame oil, soybean oil, or walnut oil.

27. The macromolecule of claim 26, wherein the cyclic carbonate monomer comprises two cyclic carbonate groups.

28-33. (canceled)

34. The macromolecule of claim 22, wherein the cyclic carbonate monomer is further functionalized by transesterification with a diol linker to form a diester of two cyclic carbonate monomer molecules, wherein the two cyclic carbonate monomer molecules are linked to each other via the diol linker.

35. The macromolecule of claim 34, wherein the diol linker is a dimer diol, a poly(ethylene glycol), or a polytetrahydrofuran (i.e., polyTHF).

36-48. (canceled)

49. A method of making a macromolecule wherein the method comprises: I) preparing an amidated prepolymer from an amine monomer and a carboxylic acid monomer via amidation reaction; II) preparing a cyclic carbonate monomer via carbonation reaction and transesterification of a vegetable oil; and III) preparing the macromolecule via urethanization reaction between the amidated prepolymer and the cyclic carbonate monomer.

50. (canceled)
